(19) United States
(12) Patent Application Publication
(10) Pub. No.: US 2017/0337497 A1
(43) Pub. Date: Nov. 23, 2017

(54) METHOD AND SYSTEM FOR CALCULATING LONG-TERM PARKING DEMAND

(71) Applicant: MasterCard International Incorporated, Purchase, NY (US)

(72) Inventors: Andrey BIRUKOV, Scarsdale, NY (US); Jean-Pierre GERARD, Croton-On-Hudson, NY (US); Amit Kumar SINGH, Agra Uttar Pradesh (IN); Ashutosh GUPTA, Varanasi Uttar Pradesh (IN); Teja CHEBROLE, Gurgaon (IN)

(73) Assignee: MasterCard International Incorporated, Purchase, NY (US)

(21) Appl. No.: 15/157,878

(22) Filed: May 18, 2016

(51) Int. Cl. G06Q 10/06

(52) U.S. Cl. CPC G06Q 10/06315; G06Q 10/06313

(57) ABSTRACT

A method and system for estimating individual propensity to use airport support services, comprising: receiving at least a first data element configured to store a specific primary account number and an addendum configured to store travel data; executing a query on a transaction database to identify a subset of transaction messages; identifying a projected level of needed airport support services propensity to use long-term parking based on at least the travel data; identifying an entity associated with needed airport support services associated with the travel transaction based on at least the travel data stored in the addendum included in the received transaction message; and transmitting the identified projected level of needed support services.

### FIELD

The present disclosure relates to a method and system for projecting a level of needed airport support services to better allocate resources, specifically by using of historical and current airline data (e.g., flight number and/or time) to identify resource demand for airports.

### BACKGROUND

In heavily urbanized areas, such as in dense cities like New Delhi, Washington, D.C., and Hong Kong, traveling via airports may become difficult. Because of the demand for resources (e.g., open kiosks, parking, etc.) many of these airports may not allocate enough resources during particular periods in time to combat airport delays.

While some airports may charge additional fees for expedited services, unfortunately, even with the addition of fees and extra parking structures, it may still be difficult and time consuming, and in some instances completely impossible, to make your flight on time. In some instances, a consumer may wait in a long line at a kiosk while they miss their flight. In other instances, a driver may spend a significant amount of time looking for a parking spot in various locations, time which could have been better spent by parking further away from their destination and walking, or taking public transportation or other alternative forms of transportation that, due to parking constraints, would have been faster.

In an effort to assist consumers with expedited airline service, many parking structures, for example, have begun to use methods for determining how many spaces are available within the structure. In some instances, the parking structure may use sensors on each parking space to identify occupancy, while, in other instances, the movement of vehicles in and out of the parking structure may be tracked.

Unfortunately, such information is often only obtainable for parking structures, is often only available for a single parking structure and not for parking in an area as a whole, and is often unavailable for different forms of parking, such as long term, short term, or offsite parking. In addition, such information is often only available if the person attempting to park physically visits the parking structure, which, if no spaces are available, may result in a wasted trip for the person, who must then spend additional time trying to find a parking space elsewhere.

In other efforts to assist consumers with expedited airline service, many airlines have implemented virtual kiosks for consumers to check in. However, these may also experience problems, for example, when the printer is out of ink, or when a consumer needs to check a bag.

Thus, there is a need for a technical solution for better resource allocation in airports.

### SUMMARY

The present disclosure provides a description of a method and system for predicting demand for airports to better allocate resources, specifically by use of historical and current airline data (e.g., flight numbers and/or times) to identify resource demand for airports based thereon.

A method for estimating individual propensity to use airport support services, comprising: storing, in a transaction database of a processing server, a plurality of transaction messages, wherein each transaction message is formatted based on one or more standards and includes data related to an electronic transaction including at least a first data element configured to store a primary account number and a plurality of additional data elements configured to store transaction data values; receiving, by a receiving device of the processing server, a transaction message related to a travel transaction, wherein the transaction message is formatted based on the one or more standards and includes at least a first data element configured to store a specific primary account number and an addendum configured to store travel data; executing, by a querying module of the processing server, in response to the received transaction message related to a travel transaction a query on the transaction database to identify a subset of transaction messages where the primary account number stored in the first data element corresponds to the specific primary account number stored in the first data element included in the received transaction message related to a travel transaction; identifying, by an analytical module of the processing server, a projected level of needed airport support services propensity to use long-term parking based on at least the travel data stored in the addendum included in the received transaction message and the transaction data values stored in the plurality of additional data elements included in one or more of the identified subset of transaction messages; identifying, by an identification module of the processing server, an entity associated with needed airport support services associated with the travel transaction based on at least the travel data stored in the addendum included in the received transaction message; and electronically transmitting, by a transmitting device of the processing server, a data signal to the identified entity superimposed with at least the identified projected level of needed support services.

A system for estimating individual propensity to use airport support services, comprising: a transaction database of a processing server configured to store a plurality of transaction messages, wherein each transaction message is formatted based on one or more standards and includes data related to an electronic transaction including at least a first data element configured to store a primary account number and a plurality of additional data elements configured to store transaction data values; a receiving device of the processing server configured to receive a transaction message related to a travel transaction, wherein the transaction message is formatted based on the one or more standards and includes at least a first data element configured to store a specific primary account number and an addendum configured to store travel data; a querying module of the processing server configured to execute in response to the received transaction message related to a travel transaction a query on the transaction database to identify a subset of transaction messages where the primary account number stored in the first data element corresponds to the specific primary account number stored in the first data element included in the received transaction message related to a travel transaction; an analytical module of the processing server configured to identify a projected level of needed airport support services propensity to use long-term parking based on at least the travel data stored in the addendum included in the received transaction message and the transaction data values stored in the plurality of additional data elements included in one or more of the identified subset of transaction messages; an identification module of the processing server configured to identify an entity associated with needed airport support services associated with the travel transaction based on at least the travel data stored in the addendum included in the received transaction message; and a transmitting device of the processing server configured to electronically transmit a data signal to the identified entity superimposed with at least the identified projected level of needed support services.

A method for estimating demand of long-term parking, comprising: storing, in a transaction database of a processing server, a plurality of transaction messages, wherein each transaction message is formatted based on one or more standards and includes data related to an electronic transaction including at least a first data element configured to store a primary account number and a plurality of additional data elements configured to store transaction data values, and wherein a subset of the transaction messages further include an addendum configured to store travel data including at least a departure date and a departure location; receiving, by a receiving device of the processing server, a data signal superimposed with a parking demand request, wherein the parking demand request includes at least a geographic location and a range of one or more dates; executing, by a querying module of the processing server, a first query on the transaction database to identify a first group of transaction messages where the departure date and the departure location included in the travel data stored in the included addendum corresponds to the range of one or more dates and geographic location, respectively; executing, by the querying module of the processing server, a second query on the transaction database to identify a second group of transaction messages where the primary account number stored in the first data element included in the respective transaction message is included in the first data element included in a transaction message in the first group of transaction messages; identifying, by an analytical module of the processing server, a propensity to use long-term parking for each primary account number stored in the first data element included in a transaction message of the identified first group of transaction messages, wherein the propensity is based on at least the travel data stored in the addendum included in a transaction message in the first group of transaction messages where the included first data element stores the respective primary account number and the transaction data values stored in the plurality of additional data elements included in one or more of the transaction messages in the second group of transaction messages where the included first data element stores the respective primary account number; estimating, by an estimation module of the processing server, a long-term parking demand based on at least the identified propensity to use long-term parking for each primary account number; and electronically transmitting, by a transmitting device of the processing server, a data signal superimposed with at least the estimated long-term parking demand.

A system for estimating demand of long-term parking, comprising: a transaction database of a processing server configured to store a plurality of transaction messages, wherein each transaction message is formatted based on one or more standards and includes data related to an electronic transaction including at least a first data element configured to store a primary account number and a plurality of additional data elements configured to store transaction data values, and wherein a subset of the transaction messages further include an addendum configured to store travel data including at least a departure date and a departure location; a receiving device of the processing server configured to receive a data signal superimposed with a parking demand request, wherein the parking demand request includes at least a geographic location and a range of one or more dates; a querying module of the processing server configured to execute a first query on the transaction database to identify a first group of transaction messages where the departure date and the departure location included in the travel data stored in the included addendum corresponds to the range of one or more dates and geographic location, respectively, and a second query on the transaction database to identify a second group of transaction messages where the primary account number stored in the first data element included in the respective transaction message is included in the first data element included in a transaction message in the first group of transaction messages; an analytical module of the processing server configured to identify a propensity to use long-term parking for each primary account number stored in the first data element included in a transaction message of the identified first group of transaction messages, wherein the propensity is based on at least the travel data stored in the addendum included in a transaction message in the first group of transaction messages where the included first data element stores the respective primary account number and the transaction data values stored in the plurality of additional data elements included in one or more of the transaction messages in the second group of transaction messages where the included first data element stores the respective primary account number; an estimation module of the processing server configured to estimate a long-term parking demand based on at least the identified propensity to use long-term parking for each primary account number; and a transmitting device of the processing server configured to electronically transmit a data signal superimposed with at least the estimated long-term parking demand.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a system architecture for projecting a level of needed airport support services in accordance with exemplary embodiments.

FIG. 2 is a block diagram illustrating the processing server of FIG. 1 for projecting a level of needed airport support services in accordance with exemplary embodiments.

FIG. 3A is a flow diagram illustrating projecting a level of needed airport support services using the system of FIG. 1 in accordance with exemplary embodiments.

FIG. 3B is a chart illustrating projecting a level of needed airport support services using the system of FIG. 1 in accordance with exemplary embodiments.

FIG. 3C is a chart illustrating projecting a level of needed airport support services using the system of FIG. 1 in accordance with exemplary embodiments.

FIG. 3D is a table illustrating projecting a level of needed airport support services using the system of FIG. 1 in accordance with exemplary embodiments.

FIG. 4A is a flow diagram illustrating projecting a level of needed airport support services using the system of FIG. 1 in accordance with exemplary embodiments.

FIG. 4B is a flow diagram illustrating projecting a level of needed airport support services using the system of FIG. 1 in accordance with exemplary embodiments.

FIG. 4C is a flow diagram illustrating projecting a level of needed airport support services using the system of FIG. 1 in accordance with exemplary embodiments.

FIG. 4D is a flow diagram illustrating projecting a level of needed airport support services using the system of FIG. 1 in accordance with exemplary embodiments.

FIG. 4E is a flow diagram illustrating projecting a level of needed airport support services using the system of FIG. 1 in accordance with exemplary embodiments.

FIG. 5 is a flow diagram illustrating projecting a level of needed airport support services using the system of FIG. 1 in accordance with exemplary embodiments.

FIG. 6A is a flow diagram illustrating projecting a level of needed airport support services using the system of FIG. 1 in accordance with exemplary embodiments.

FIG. 6B is a flow diagram illustrating projecting a level of needed airport support services using the system of FIG. 1 in accordance with exemplary embodiments.

FIG. 7 is a flow chart illustrating projecting a level of needed airport support services using the system of FIG. 1 in accordance with exemplary embodiments.

FIG. 8 is a flow chart illustrating projecting a level of needed airport support services using the system of FIG. 1 in accordance with exemplary embodiments.

FIG. 9 is a flow diagram illustrating the processing of a payment transaction in accordance with exemplary embodiments.

FIG. 10 is a block diagram illustrating a computer system architecture in accordance with exemplary embodiments.

FIG. 11 is a diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have and require special knowledge in offered products. In some embodiments, an entity involved in a single transaction may be considered a merchant. In some instances, as used herein, the term “merchant” may refer to an apparatus or device of a merchant entity.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

### System for Projecting a Level of Needed Airport Support Services

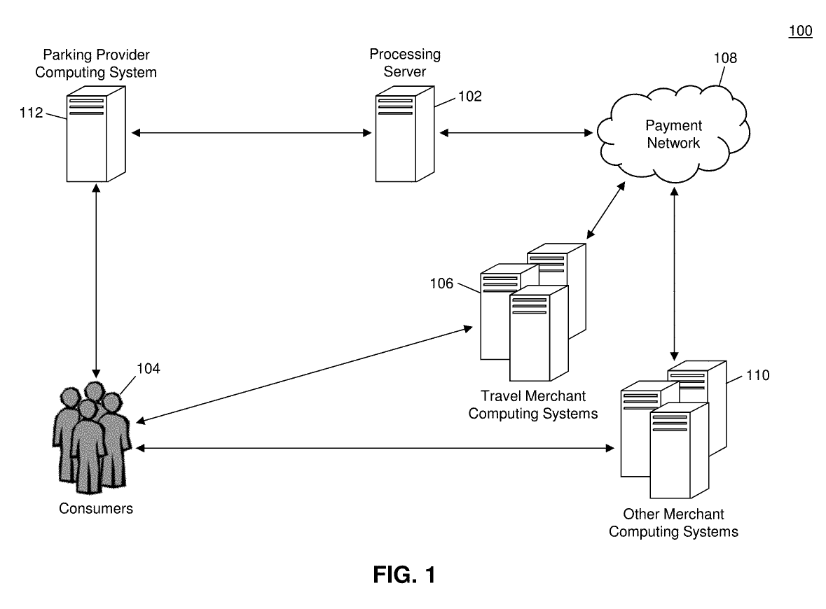

FIG. 1 illustrates a system 100 for projecting a level of needed airport support services.

The system 100 may include a processing server 102. The processing server 102, discussed in more detail below, may be configured to generate data correlations between airport metrics and transaction behaviors, including the generation of the transaction behaviors based on payment transaction data, and use of the generated data correlations in the estimation of parking metrics and airline kiosks. The processing server 102 may be one or more computing systems specially configured to perform the functions disclosed herein, thereby comprising a special purpose computing system. The processing server 102 may be configured to receive and store parking metrics and airline metrics for one or more airports, and receive and store transaction data for payment transactions in one or more airports, and use these disparate data sets to generate data correlations to improve the efficiency of airports.

In the system 100, parking metrics and airline metrics may be provided to the processing server 102 by one or more data providers such as a parking provider computing system 112, a travel merchant computing system 106, and/or other merchant computing systems 110. Data providers may include governmental agencies, parking businesses, research agencies, survey firms, transportation agencies, and other data sources that may be configured to collect parking metrics and airline metrics to provide to the processing server 102. The data providers may communicate with the processing server 102 via one or more suitable communication networks, which may include the Internet, cellular communication networks, local area networks, radio frequency, etc. Data signals may be superimposed with parking metrics and airline metrics by computing devices of the data providers, which may be electronically transmitted via the communication network to the processing server 102. The processing server 102 may receive the data signals and parse the data superimposed thereon to obtain the parking metrics and airline metrics. The processing server 102 may store the data received from the data providers in a data structure, wherein the stored data may be standardized for implementation in the systems and methods described herein.

As discussed in more detail below, the processing server 102 may store the parking metrics and airline metrics as standardized data sets in a database, which may be locally stored in the processing server 102 or stored in an external database and accessed remotely, such as via the same or an alternative communication network using data signals for communication. For example, in some embodiments, parking metrics and airline metrics may be stored in external data storage and accessed using one or more cloud computing techniques that will be apparent to persons having skill in the relevant art.

The data signals received by the processing server 102, from the data providers, may comprise data related to one or more entities which may be directly or indirectly associated with parking availability and parking services in one or more particular locations. In some embodiments, the data signals may comprise data related to parking of an airport and/or airline data (e.g., tickets purchases, tickets canceled, flights booked, flights overbooked, flights not completely booked). The data signals may comprise additional data related thereto, e.g., location, parking capacity, rates (particularly for parking providing entities, etc.), hours of operation, airport location capacity, flight data, average amount of time spent by a consumer at airport, etc.

In some embodiments, the processing server 102 may receive data submitted directly or indirectly from an entity device via a communications network. The data acquired by the processing server 102 may be aggregated and stored in one or several databases.

The system 100 may also include a payment network 108. The payment network 108 may be configured to process payment transactions and obtain transaction data associated thereto. Transaction data may include transaction amounts, transaction times and/or dates, geographic locations, merchant data, consumer data, offer data, reward data, loyalty data, product data, etc. As part of the processing of payment transactions, the payment network 108 may receive transaction messages. Transaction messages may be specially formatted data sets that are formatted based on one or more standards, such as the International Organization for Standardization's ISO 8583 standard.

Transaction messages may include a plurality of data elements, each data element being configured to store data as set forth in the associated standard(s), such as data elements configured to store primary account numbers, merchant category codes, merchant identifiers, geographic locations, transaction amounts, transaction times, etc. Transaction messages may be communicated using specially configured infrastructure that utilizes specialized communication protocols, known to persons having skill in the art as “payment rails.” The payment rails may be specialized infrastructure specially configured for the secure transmission of transaction messages and other sensitive financial information, and may be access only via specialized computing systems and not by general purpose computers lacking the specialized programming required for communications with the payment rails infrastructure.

The processing server 102 may be configured to obtain transaction data from the payment network 108. In some embodiments, the payment network 108 may provide the processing server 102 with transaction messages for a plurality of payment transactions. In such embodiments, the processing server 102 may be specially configured to communicate with the payment network 108 using the payment rails and be configured to receive transaction messages, formatted based on the associated standards, using the specialized infrastructure and protocols of the payment rails. In some instances, the processing server 102 may electronically transmit a data signal to the payment network 108 via the payment rails or an alternative communication network requesting the transaction messages. In other instances, the payment network 108 may periodically transmit transaction messages to the processing server 102, where the period may be established by the processing server, payment network 108, or suitable criteria, such as based on the needs of the processing server 102 in providing the data.

The processing server 102 may be configured to parse the received transaction messages to obtain the data stored in the data elements included therein. In other embodiments, the payment network 108 may superimpose data signals with transaction data for payment transactions, which may be transmitted to the processing server 102 using other suitable communication networks, such as the Internet or cellular communication networks. In some instances, transaction data transmitted to the processing server 102 for use in performing the functions discussed herein may have some data removed. For example, the data stored in some data elements may be removed from the transaction messages prior to transmission or superimposition, such as account numbers, consumer data, or other data that may not be used by the processing server 102 or may be removed to protect consumer privacy or security.

The processing server 102 may be configured to generate data correlations between airport parking, airline data, and transaction behaviors. For a given airport and time and/or date range, the processing server 102 may execute queries on databases storing transaction data, airline metrics, and parking metrics. The processing server 102 may identify transaction behaviors for the geographic area and time and/or date range based on the identified transaction data.

Transaction behaviors may include, for example, transaction frequency, parking purchase frequency, transportation purchase frequency, number of transaction, transaction merchant types, average ticket amount, propensity to spend on parking, parking and transportation spend ratios, etc. The transaction behaviors may be based on the transaction data for one or more payment transactions conducted in the geographic area during the time and/or date range.

### Processing Server

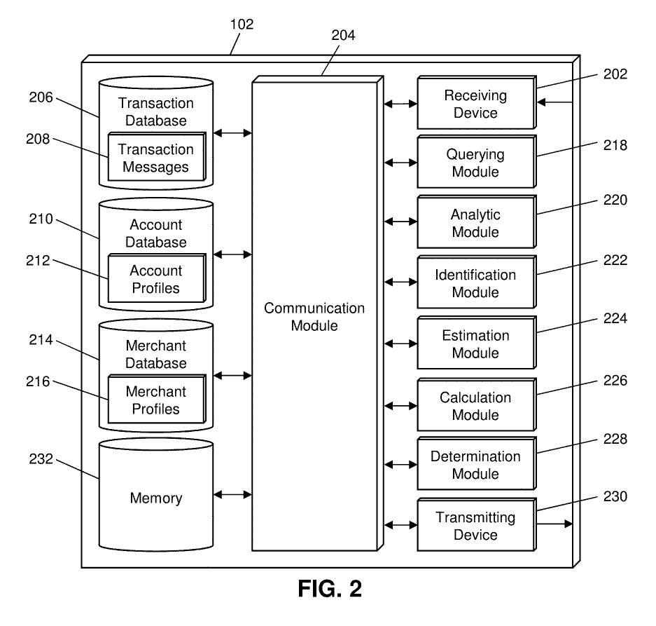

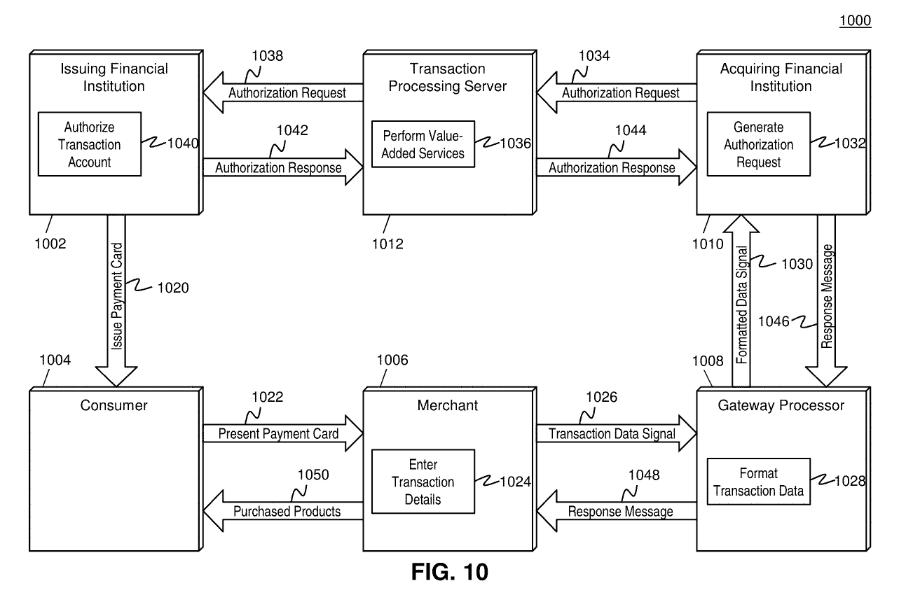

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 1100 illustrated in FIG. 10 and discussed in more detail below may be a suitable configuration of the processing server 102. As used herein, the term “module” denotes the software and/or hardware configured to receive a specified input, perform a process thereon, and execute an output based upon the process performed by the module.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 108 for the transmission of transaction messages that include sensitive financial data and information. In some embodiments, the receiving device 202 may be comprised of multiple units, such as different receiving units for receiving data over different networks, such as a first receiving unit for receiving data over payment rails and a second receiving unit for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon.

The receiving device 202 may be configured to receive data signals electronically transmitted by the data providers (e.g., 112, 106, 110) superimposed with data comprising parking metrics (which may include parking metrics for a plurality of date and/or time ranges and geographic areas), travel merchant transactions, and/or other merchant computing system data. The receiving device 202 may also be configured to receive data signals electronically transmitted by the payment network 108 superimposed with data comprising transaction data for a plurality of payment transactions. In some embodiments, the transaction data may be comprised in transaction messages, which may be electronically transmitted by the payment network 108 and received by the receiving device 202 using the payment rails. Transaction data received by the receiving device 202 may be for a plurality of payment transactions and include at least a time and/or date and geographic area for the payment transaction, as well as additional data suitable for use in performing the functions discussed herein, such as merchant category data.

In some implementations, the receiving device 202 may be configured to receive a transaction message related to a travel transaction, wherein the transaction message is formatted based on the one or more standards and includes at least a first data element configured to store a specific primary account number and an addendum configured to store travel data. The travel data may include at least one of: departure airport, arrival airport, date of departure, date of arrival, time of departure, time of arrival, and/or length of travel.

The receiving device 202 may receive a data signal superimposed with a parking demand request. The parking demand request may include at least a geographic location and/or a range of one or more dates. The receiving device 202 of the processing server 102 may be configured to receive a personnel cost for each n for a transportation center. A plurality of transaction data entries may include a structured data set related to a payment transaction and transaction data. The receiving device 202 of the processing server 102 may further be configured to receive a baggage cost for each b for the transportation center. The operation cost may be calculated for each n for each b to further include the respective baggage cost.

The processing server 102 may include a querying module 218. The querying module 218 may execute, in response to the received transaction message related to a travel transaction, a query on the transaction database to identify a subset of transaction messages where the primary account number stored in the first data element corresponds to the specific primary account number stored in the first data element included in the received transaction message related to a travel transaction.

In some implementations, the querying module 218 may a first query on the transaction database 206 to identify a first group of transaction messages where the departure date and the departure location included in the travel data stored in the included addendum corresponds to the range of one or more dates and geographic location, respectively.

In some implementations, the querying module 218 may execute a second query on the transaction database 206 to identify a second group of transaction messages where the primary account number stored in the first data element included in the respective transaction message is included in the first data element included in a transaction message in the first group of transaction messages.

The processing server 102 may include an analytic module 220. The analytic module 220 may identify a projected level of needed airport support services propensity to use long-term parking based on at least the travel data stored in the addendum included in the received transaction message and the transaction data values stored in the plurality of additional data elements included in one or more of the identified subset of transaction messages.

The analytical module 220 may identify a propensity to use long-term parking for each primary account number stored in the first data element included in a transaction message of the identified first group of transaction messages. The propensity may be based on at least the travel data stored in the addendum included in a transaction message in the first group of transaction messages where the included first data element stores the respective primary account number and the transaction data values stored in the plurality of additional data elements included in one or more of the transaction messages in the second group of transaction messages where the included first data element stores the respective primary account number. The travel data may further include at least one of: departure airport, arrival airport, date of arrival, time of departure, time of arrival, and length of travel.

In some implementations, the analytical module 220 may be configured to identify an average time-based value for passengers of the transportation center based on passenger income. Identifying the average time-based value for passengers of the transportation center may include: analyzing transaction data included in the received transaction data entries to identify an estimated income for passengers of the transportation center and/or identifying the time-based value based on the estimated income over time.

In some implementations, identifying the average time-based value for passengers of the transportation center may include receiving demographic information for a geographic area associated with the transportation center. In some implementations, the demographic information may be one or more of: age, ethnicity, education, household composition, professional and/or employment status. The demographic information may include at least an estimated average income. The analytical module may identify the time-based value based on the estimated average income over time. The time period may be predetermined, and/or set by an operation administrator.

The processing server 102 may include an identification module 222. The identification module 222 may identify an entity associated with needed airport support services associated with the travel transaction based on at least the travel data stored in the addendum included in the received transaction message.

The processing server 102 may include an estimation module 224, which may estimate a long-term parking demand based on at least the identified propensity to use long-term parking for each primary account number.

The processing server 102 may include a calculation module 226 configured to calculate an operation cost for each n based on at least a combination of the respective personnel cost and passenger value as a product of the respective passenger wait time, average number of passengers, and/or average time-based value.

The processing server 102 may include a determination module 228 configured to determine an average number of passengers of the transportation center based on at least the transaction data included in each received transaction data entry. The determination module 228 may be further configured to determine an ideal number of security personnel based on the calculated operation cost for each n number of security personnel. In some implementations, the ideal number of security personnel may be a number of security personnel having the lowest respective calculated operation cost.

The processing server 102 may further include a transmitting device 230. The transmitting device 230 may be configured to transmit data over one or more networks via one or more network protocols. In some embodiments, the transmitting device 230 may be configured to transmit data over the payment rails, such as using specially configured infrastructure associated with payment networks 108 for the transmission of transaction messages that include sensitive financial data and information, such as identified payment credentials.

In some instances, the transmitting device 230 may be configured to electronically transmit a data signal to the identified entity superimposed with at least the identified projected level of needed support services.

The transmitting device 230 may electronically transmit data signals that have data superimposed that may be parsed by a receiving computing device. In some instances, the transmitting device 230 may include one or more modules for superimposing, encoding, or otherwise formatting data into data signals suitable for transmission.

The transmitting device 230 may be configured to transmit data requests to the data providers (e.g., 112, 106, 110) and payment networks 108, such as to request parking data or transaction data for use in performing the functions discussed herein. In some embodiments, data requests may be transmitted separately from requests for data received by the receiving device 202. In other embodiments, the transmitting device 230 may transmit data requests for data for use in estimating parking metrics based on a received data request, such as for requesting transaction data for payment transaction at a specific date and/or time for which estimated parking metrics are requested. The transmitting device 230 may also be configured to electronically transmit data signals to the requesting entity superimposed with estimated parking metrics, such as in response to a request for parking metrics electronically transmitted by the requesting entity and received by the receiving device 202. In some implementations, the transmitting device 230 may be a data signal superimposed with at least the estimated long-term parking demand.

The processing server 101 may comprise a plurality of databases, including a transaction database 206, an account database 210, a merchant database 214, and/or any other database. The databases of a processing server 101 may be configured to store a plurality of passenger wait times. Each passenger wait time may correspond to a number of personnel, n, and may be representative of a wait time at airport security for a passenger with n security personnel employed. The database of the processing server may further be configured to store a baggage wait time, wherein the baggage wait time is representative of a wait time for baggage by an arriving passenger. The passenger value may be used in calculating the operation cost for each n is a product of the average time-based value, average number of passengers, and a greater of the respective passenger wait time and the baggage wait time.

The databases of the processing server may further configured to store a plurality of baggage wait times. Each baggage wait time may correspond to a number of baggage personnel, b, and is representative of a wait time for bagging by an arriving passenger with n baggage personnel employed. The operation cost corresponding to each n may be calculated for each b, where the passenger value used in calculating the respective operation cost is a product of the average time-based value, average number of passengers, and a greater of the respective passenger wait time and the baggage wait time corresponding to the respective b. The ideal number of security personnel may be determining an ideal number of baggage personnel based on the calculated operation cost for each n number of security personnel for each b number of baggage personnel. Each passenger wait time may further correspond to one of a plurality of times of day. Determining an average number of passengers of the transportation center may include determining an average number of passengers of the transportation center for each time of day based on at least the transaction data included in each received transaction data entry. The operation cost for each n may be based on at least a combination of the respective personnel cost and passenger value as a product of the respective passenger wait time, average number of passengers, and average time-based value for each of the plurality of times of day. Each transaction data entry may be a transaction message formatted based on one or more standards. Each transaction message may include addendum data including travel data indicating the transportation center. The one or more standards may include the ISO 8583 standard.

The processing server 102 may also include a transaction database 206, which may store a plurality of transaction messages. Each transaction message may be formatted based on one or more standards and includes data related to an electronic transaction including at least a first data element configured to store a primary account number and a plurality of additional data elements configured to store transaction data values.

The transaction data values may include at least one of: transaction time, transaction date, transaction amount, merchant category, merchant name, geographic location, merchant data, and product data. At least one of the transaction message included in the identified subset of transaction messages may include an addendum configured to store travel information. The identified propensity may further be based on the travel information stored in the addendum included in the at least one transaction message. In some implementations, the identified propensity may be further based on one or more transaction messages related to the at least one transaction message where a merchant category included in the transaction data values stored in the included plurality of additional data elements is representative of a parking, rental car, or transportation merchant. Transaction database 206 may store a plurality of transaction messages. Each transaction message may be formatted based on one or more standards and includes data related to an electronic transaction including at least a first data element configured to store a primary account number and a plurality of additional data elements configured to store transaction data values. The subset of the transaction messages may further include an addendum configured to store travel data including at least a departure date and a departure location. The parking demand request may further include one or more parking capacities. The estimated long-term parking demand may further be based on the one or more parking capacities.

The processing server 102 may include an account database 210. The account database 210 may store data associated with a consumer and/or merchant based on transactions and/or any other account variables.

The processing server 102 may include a merchant database 214. The merchant database 214 may store data associated with a merchant and/or consumer based on transactions and/or any other variables.

The processing server 102 may also include a memory 232. The memory 232 may be configured to store data for use by the processing server 102 in performing the functions discussed herein. The memory 232 may be configured to store data using suitable data formatting methods and schema and may be any suitable type of memory, such as read-only memory, random access memory, etc. The memory 232 may include, for example, encryption keys and algorithms, communication protocols and standards, data formatting standards and protocols, program code for application programs, rules and algorithms for generating transaction behaviors, and other data that may be suitable for use by the processing server 102 in the performance of the functions disclosed herein as will be apparent to persons having skill in the relevant art.

In an exemplary embodiment, a user device storing an application configured to communicate with the processing server 102 may initiate a communication with the processing server 102. For instance, a user may input a selection of an area (e.g., by touching a display of an area on a map displayed by the application, by inputting or selecting from a list a neighborhood, street, block range, etc.). The user device may transmit the user selection to the processing server 102. The processing server may identify, in one or more databases, parking-related data and/or analytical results of the processing server 102 for the area identified by the user selection. The processing server may cause the parking-related analysis/data to be transmitted to the user device for display thereon. The user may view the result provided by the processing server visually, via the application, (e.g., as text “search time for parking is 15 minutes”, an icon superimposed on a map displayed by the device, etc.).

### Flow Diagram for Projecting a Level of Needed Airport Support Services

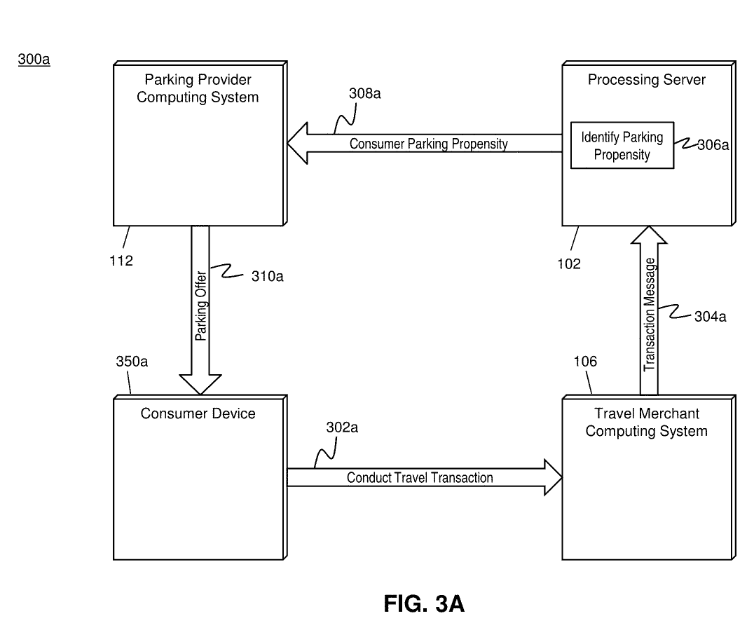

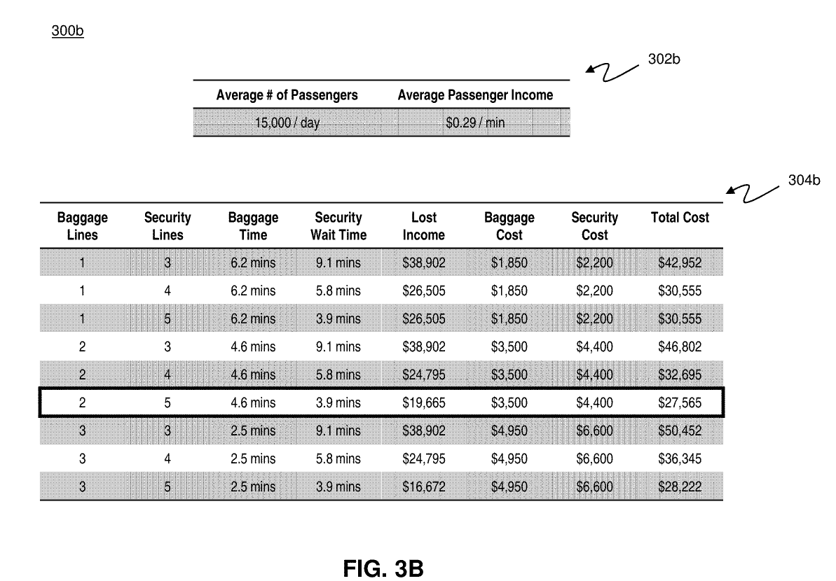

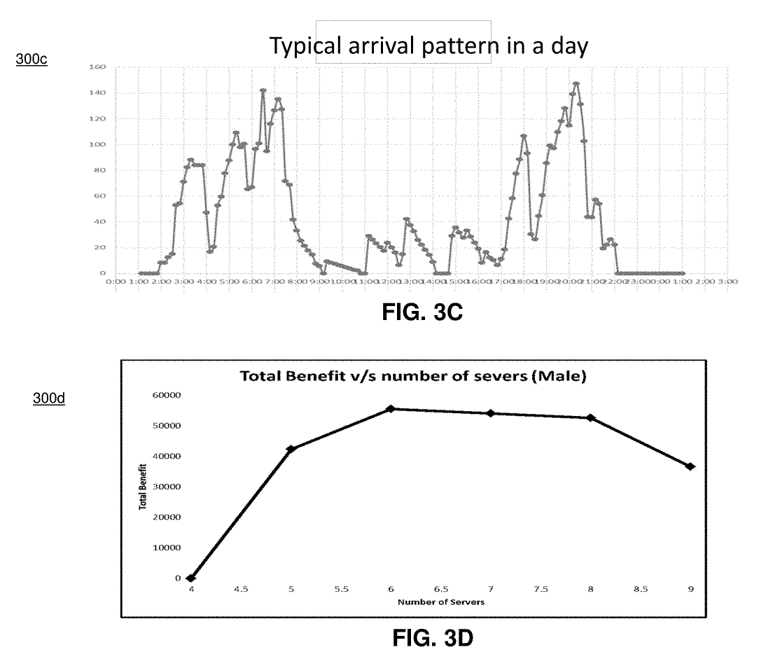

FIG. 3A is a flow diagram 300a illustrating projecting a level of needed airport support services using the system of FIG. 1 in accordance with exemplary embodiments.

The processing server 102 may be configured to identify parking propensity 306a by generating data correlations between airport metrics and transaction behaviors, including the generation of the transaction behaviors based on payment transaction data, and use of the generated data correlations in the estimation of parking metrics and airline kiosks. The processing server 102 may be one or more computing systems specially configured to perform the functions disclosed herein, thereby comprising a special purpose computing system. The processing server 102 may be configured to receive and store parking metrics and airline metrics for one or more airports, and receive and store transaction data for payment transactions in one or more airports, and use these disparate data sets to generate data correlations to improve the efficiency of airports.

The parking provider computing system 112 may be configured to transmit parking offers 310a to consumers on their consumer devices 350a based on consumer parking propensity 308a data received from the processing server 102. The consumer parking propensity 308a is based on identified parking propensity 306a which may be determined by the processing server based on parking metrics.

The parking metrics and airline metrics may be provided to the processing server 102 by one or more data providers such as a parking provider computing system 112, a travel merchant computing system 106, and/or other merchant computing systems 110. Data providers may include governmental agencies, parking businesses, research agencies, survey firms, transportation agencies, and other data sources that may be configured to collect parking metrics and airline metrics to provide to the processing server 102. The data providers may communicate with the processing server 102 via one or more suitable communication networks, which may include the Internet, cellular communication networks, local area networks, radio frequency, etc. Data signals may be superimposed with parking metrics and airline metrics by computing devices of the data providers, which may be electronically transmitted via the communication network to the processing server 102. The processing server 102 may receive the data signals and parse the data superimposed thereon to obtain the parking metrics and airline metrics. The processing server 102 may store the data received from the data providers in a data structure, wherein the stored data may be standardized for implementation in the systems and methods described herein.

The processing server 102 may store the parking metrics and airline metrics as standardized data sets in a database, which may be locally stored in the processing server 102 or stored in an external database and accessed remotely, such as via the same or an alternative communication network using data signals for communication. For example, in some embodiments, parking metrics and airline metrics may be stored in external data storage and accessed using one or more cloud computing techniques that will be apparent to persons having skill in the relevant art.

The data signals received by the processing server 102, from the data providers, may comprise data related to one or more entities which may be directly or indirectly associated with parking availability and parking services in one or more particular locations. In some embodiments, the data signals may comprise data related to parking of an airport and/or airline data (e.g., tickets purchases, tickets canceled, flights booked, flights overbooked, flights not completely booked). The data signals may comprise additional data related thereto, e.g., location, parking capacity, rates (particularly for parking providing entities, etc.), hours of operation, airport location capacity, flight data, average amount of time spent by a consumer at airport, etc.

In some embodiments, the processing server 102 may receive data submitted directly or indirectly from an entity device via a communications network. The data acquired by the processing server 102 may be aggregated and stored in one or several databases.

The consumer device 350a may be configured to receive parking offers 310a from one or more parking provider computing system 112. When the consumer utilizes the parking offer 310a, the travel merchant computing system receives notification of a travel transaction being conducted 302a via the consumer device 350a. Airline transactions and/or parking transactions (e.g., transaction data) are transmitted via transaction messages 304a to the processing server 102. Transaction data may include transaction amounts, transaction times and/or dates, geographic locations, merchant data, consumer data, offer data, reward data, loyalty data, product data, etc. As part of the processing of payment transactions, the processing server 102 may receive transaction messages.

Transaction messages may include a plurality of data elements, each data element being configured to store data as set forth in the associated standard(s), such as data elements configured to store primary account numbers, merchant category codes, merchant identifiers, geographic locations, transaction amounts, transaction times, etc. Transaction messages may be communicated using specially configured infrastructure that utilizes specialized communication protocols, known to persons having skill in the art as “payment rails.” The payment rails may be specialized infrastructure specially configured for the secure transmission of transaction messages and other sensitive financial information, and may be access only via specialized computing systems and not by general purpose computers lacking the specialized programming required for communications with the payment rails infrastructure.

The processing server 102 may be configured to obtain transaction data from the travel merchant computing system 106 and/or the parking provider computing system 112. The processing server 102 may be configured to parse the received transaction messages to obtain the data stored in the data elements included therein. In other embodiments, the payment network 108 may superimpose data signals with transaction data for payment transactions, which may be transmitted to the processing server 102 using other suitable communication networks, such as the Internet or cellular communication networks. In some instances, transaction data transmitted to the processing server 102 for use in performing the functions discussed herein may have some data removed. For example, the data stored in some data elements may be removed from the transaction messages prior to transmission or superimposition, such as account numbers, consumer data, or other data that may not be used by the processing server 102 or may be removed to protect consumer privacy or security.

The processing server 102 may be configured to generate data correlations between airport parking, airline data, and transaction behaviors. For a given airport and time and/or date range, the processing server 102 may execute queries on databases storing transaction data, airline metrics, and parking metrics. The processing server 102 may identify transaction behaviors for the geographic area and time and/or date range based on the identified transaction data.

Transaction behaviors may include, for example, transaction frequency, parking purchase frequency, transportation purchase frequency, number of transaction, transaction merchant types, average ticket amount, propensity to spend on parking, parking and transportation spend ratios, etc. The transaction behaviors may be based on the transaction data for one or more payment transactions conducted in the geographic area during the time and/or date range.

FIG. 3B is a chart 300b illustrating projecting a level of needed airport support services using the system of FIG. 1 in accordance with exemplary embodiments. Airports traditionally decrease the number of security check in counters to minimize the total cost in the system. By increasing the security check in counters, the cost increases for the airport authority. When there are too few of a number of security check in counters, the waiting time for passengers increases, which is an opportunity loss for other merchants within the terminal, who may provide services and/or goods to a consumer, but cannot due to the longer wait time.

There is a tradeoff between waiting time and the cost of installing and operating check in counters. The tradeoff may be determined by converting the waiting time into monetary value by calculating the monetary value and minimizing the entire cost for the system. In order to provide an optimized system, the cost of security check in counters and the monetary value of waiting costs need to be minimized. Factors in airports to consider may be one or more of: a number of optimal security check in counters that airports may have, a number of security check in counters that must be operating on a day to day to basis to minimize the cost based on the demand at the airport on a day, and/or a number of security check in counters at airport to minimize the total cost in the system.

Data is extracted from companies may include addendum data which provides stock keeping unit (SKU) level data. By analyzing the SKU level data, the time of departure at a particular airport for various passengers may be determined. The arrival pattern for the consumers throughout the day may be determined as shown by 300b. The demand can be determined for a weekday and weekends and/or other high demand period to arrive at different arrival patterns. Using this data, the system can arrive at an average arrival pattern by averaging the arrival pattern throughout the year.

An example of the type of data is shown in Table 1 below.

Sample SKU level data and fields may comprise one or more of: different colors, transaction key, individual key, store id, transaction date, product code, product spend, total basket spend, total basket quantity, total product quantity, transaction key, individual key, transaction date, product code, product spend, total basket spend, total basket quantity, and/or total product quantity. The different colors may represent different baskets. ‘Transaction_key’ may represent unique for each basket. ‘Individual_key’ may represent the unique key for the customer making the purchase. ‘Store_id’ may represent the unique key for the store the customer is buying from. ‘Transaction date’ may represent the date when the transaction happened. ‘Product code’ may represent the unique code for the product. ‘Product_spend’ may represent the spend on the product mentioned in the record. ‘Total_basket_spend’ may represent the total spend on all items in the basket. ‘Total_basket_quantity’ may represent the total quantity of all the items in the basket. ‘Total_product_quantity’ may represent the quantity of only the product mentioned in the record.

Table 2 shows an example of how the calculation works.

TABLE 2

| | |
|---|---|
| Average number of passenger arrival per hour (λ) | 200 |
| Percentage of Male (Source: Official airport authority of | 76% |
| country e.g. DGCA for India) | |
| Number of Male passenger in a day | 3648 |
| Number of female passenger in a day | 1152 |

The average number of passenger arrival may be determined from the transaction data (e.g., credit card data) as detailed above. In an exemplary embodiment, a different analysis for male and female may be conducted in an embodiment where both would have different check in counters.

An example of the cost of installing an extra security check in counter is illustrated in Table 3 below.

TABLE 3
Extra cost per day of installing an extra check in

| Factor | Cost |
|---|---|
| Land | $6,500 |
| Machinery | $3,000 |
| Human Resource | $5,000 |
| Miscellaneous (electricity, maintenance etc.) | $1,500 |
| Total | $16,000 |

FIG. 3C is a chart 300c illustrating projecting a level of needed airport support services using the system of FIG. 1 in accordance with exemplary embodiments. In an exemplary embodiment, the cost of installing an extra security check in counter at an optimum cost may be determined. Average check in time at airport from secondary sources may be calculated. Thus, the total waiting time is calculated for consumers corresponding to a different number of check in counters. The average income of people travelling via airport in the city may also be collected from secondary sources. This information is used to convert the waiting time of passenger into monetary value in order to optimize the total cost.

The data collected in Table 4 provides an exemplary calculation corresponding to the benefit achieved on adding extra check in counters assuming an initial number of check counters are 4. The type of information collected may be: number of servers, average residence time per passenger, extra servers, time saved per passenger, total time saved, total money saved, cost of an extra server, and/or total benefit.

TABLE 4a

| Number of | Average Residence Time | | Time Saved |
|---|---|---|---|
| servers | per passenger (m [symbol] | Extra Server | per passenger |
| 4 | 15 | 0 | 0 |
| 5 | 11 | 1 | 4 |
| 6 | 9 | 2 | 6 |
| 7 | 8 | 3 | 7 |
| 8 | 7 | 4 | 8 |
| 9 | 7 | 5 | 8 |

[symbol]

indicates data missing or illegible when filed

TABLE 4b

| | | | Total |
|---|---|---|---|
| Total time saved | Total money saved | Cost of extra server | Benefit |
| 0 | 0 | 0 | 0 |
| 14592 | 58368 | 16000 | 42368 |
| 21888 | 87552 | 32000 | 55552 |
| 25536 | 102144 | 48000 | 54144 |
| 29184 | 116736 | 64000 | 52736 |
| 29184 | 116736 | 80000 | 36736 |

Based on charting the information in Table 4 above, as shown in by 300c, the suggested optimal number of check in counters is 6 for male passengers to maximize the total benefit.

FIG. 3D is a flow diagram 300d illustrating projecting a level of needed airport support services using the system of FIG. 1 in accordance with exemplary embodiments. Various factors are considered in determining a projected level of needed airport support services. Variables shown in 302d such as average number of passengers and average passenger income are important factors to consider. Other factors which may be considered are shown in 304d. These factors include: number of baggage lines, security lines, baggage time, security wait time, lost income, baggage cost, security cost, and total cost. In this exemplary embodiment, it is evident that providing two baggage lines and five security lines provides the most benefit to the airport.

### Exemplary Embodiments of Projecting a Level of Needed Airport Support Services

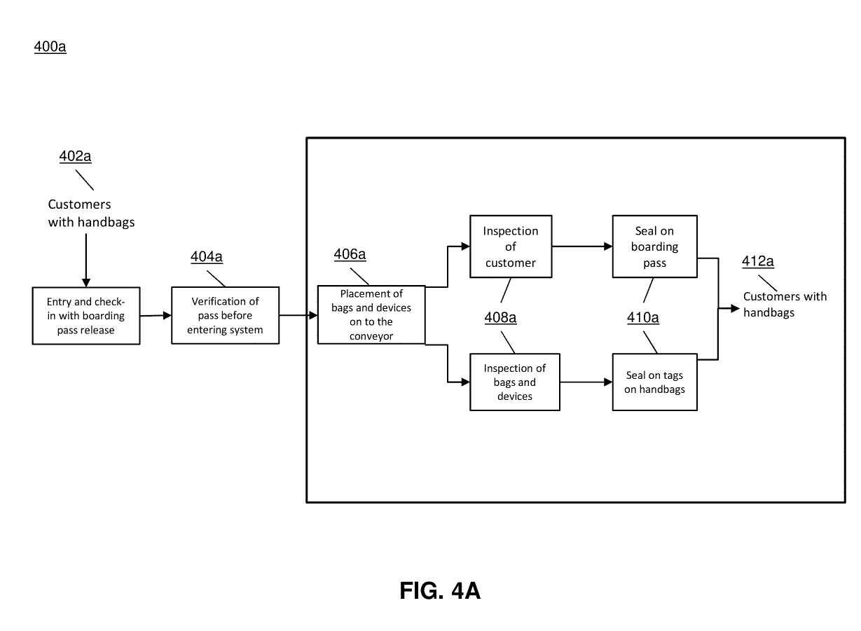

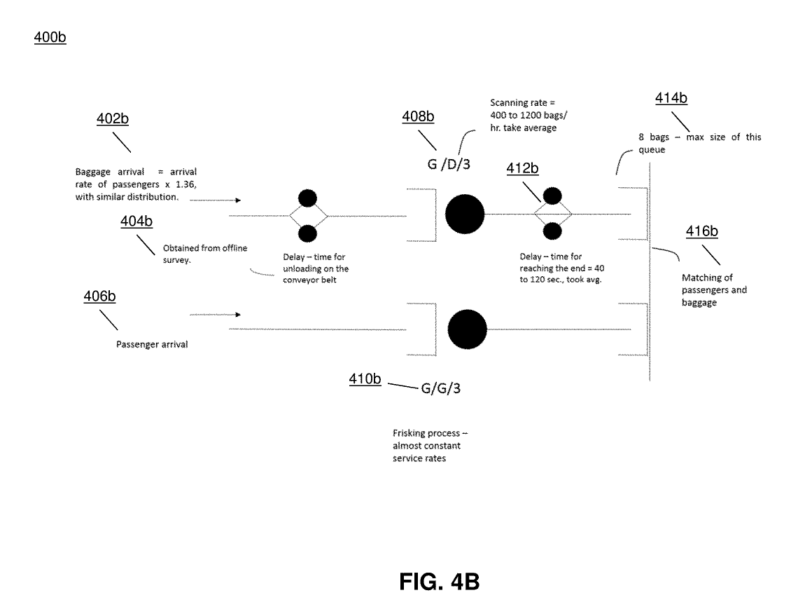

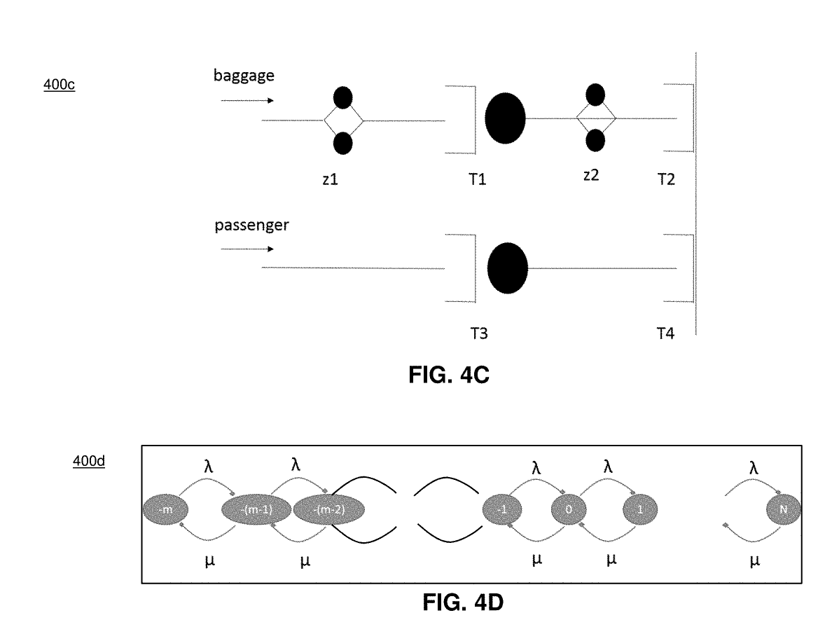

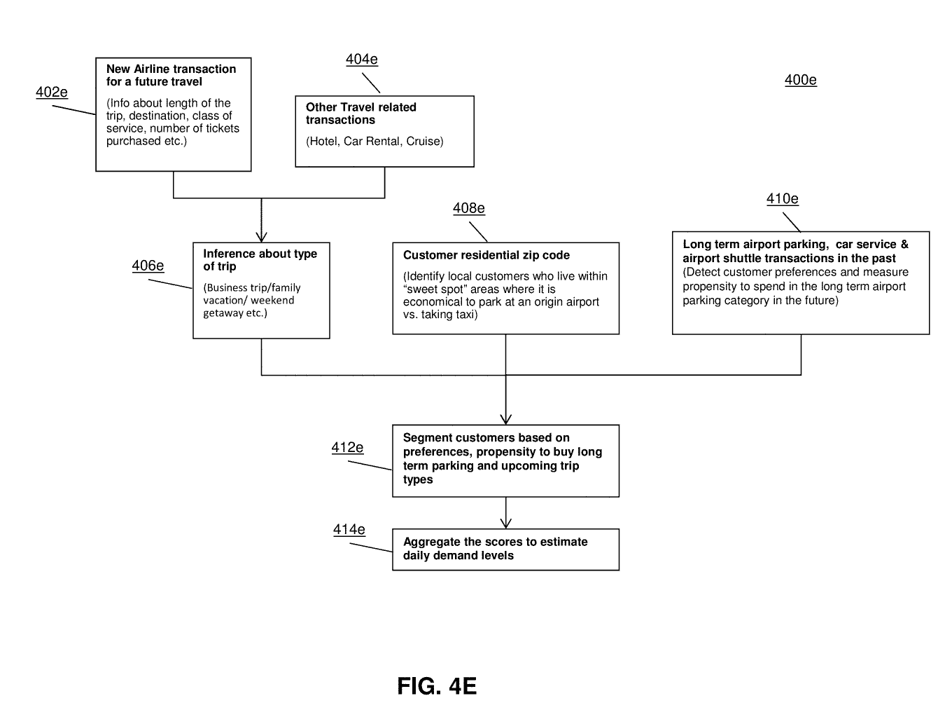

FIG. 4A is a flow diagram 400a illustrating projecting a level of needed airport support services using the system of FIG. 1 in accordance with exemplary embodiments.

Airports traditionally decrease the number of security check in counters to minimize the total cost in the system. By increasing the security check in counters, the cost increases for the airport authority. When there are too few of a number of security check in counters, the waiting time for passengers increases, which is an opportunity loss for other merchants within the terminal, who may provide services and/or goods to a consumer, but cannot due to the longer wait time.

There is a tradeoff between waiting time and the cost of installing and operating check in counters. The tradeoff may be determined by converting the waiting time into monetary value by calculating the monetary value and minimizing the entire cost for the system. In order to provide an optimized system, the cost of security check in counters and the monetary value of waiting costs need to be minimized.

For example, in step 402a, passengers (e.g., consumers) with handbags may check-in with a boarding pass. In step 404a, verification of the boarding pass may be determined before the passenger enters the system. In step 406a, the placement of bags and devices on the conveyor may be determined. At step 408a, while the passenger is inspected, the bag and devices of the consumer are inspected. At step 410a the passenger's boarding pass and handbags may be sealed and/or tagged as inspected. At step 412a, the number of passengers with handbags may be determined.

FIG. 4B is a flow diagram 400b illustrating projecting a level of needed airport support services using the system of FIG. 1 in accordance with exemplary embodiments.

One way of projecting an accurate level of needed airport support services comprises 3 steps which are given below.

Step 1: Determine the relationship between lead time of passengers and number of servers added. In some implementations, the model may be used for a single server 400b shown in FIG. 4B. The servers may be duplicated, analyzed and solved for finding the relationship between lead time and number of servers.

In step 402b, a baggage arrival period may be calculated as the arrival rate of passengers times a coefficient. In step 404b, a delay time for unloading on the conveyor belt may be determined. In some implementations, this may be obtained from an offline survey. In step 406b, passengers may arrive. In step 408b, a scanning rate may be determined (e.g., 400-1200 bags/hr). In step 410b, the rate of the frisking process may be determined, which may typically be a constant rate. In step 412, a delay is calculated (e.g., time for the bags to reach the end, 40-120 seconds may be the average). In step 414b, the max size of the baggage queue is determined (e.g., 8 bags may be queued depending on the size of the baggage queue). In step 416b, the passengers may be matched to their baggage.

The values mentioned in FIG. 4B may be obtained by conducting surveys and observations at the airport. The arrival data, may be drawn from using transaction data (e.g., from a credit card company). Kendall notations used to describe and classify a queuing node may be implemented in the subsystems via frisking and scanning and are arrived at by looking at the arrival and service processes and observing the means and coefficients of variations of the inter-arrival and service times.

Step 2: Use conversion factors to get money-equivalents of the lead time and secondary sources to determine the fixed costs incurred for marginal increase in servers.

Step 3: The optimal number of servers may be determined by using cost-benefit analysis.

FIG. 4C is a flow diagram 400c illustrating projecting a level of needed airport support services using the system of FIG. 1 in accordance with exemplary embodiments.

In an exemplary embodiment, calculations may be implemented in the cost-benefit analysis. For example, residence time calculations may comprise:

T_{b}=z1+T1+z2+T2−baggage

Tₚ=T3+T4−passengers

The delay times are z1 and z2 and T1, T2, T3 and T4 are the times spent waiting in queues. In an exemplary embodiment, suppose z1=50 seconds and z2=80 seconds (known from secondary research and survey); S is the number of server which is equal to 3; λ is the arrival rate of passenger; and μ is the processing speed of the machine. T1 is the residence time for an M/M/3 system with λ=306 per hour and μ=800 per hour (machine).

$$T 1 = ( su + \frac{π ( 0 )}{S ! {( 1 - u )}^{⋀} 2} {s}^{s} {u}^{s + 1} ) \times 1 / λ$$

$$where s = 3 , u = \frac{λ}{s μ} = .1275$$

$$π ( 0 ) = \frac{1}{{\sum }_{0}^{s - 1} \frac{{( su )}^{x}}{x !} + \frac{{( su )}^{s}}{( 1 - u ) s !}} = .682$$

$$T 1 = .001253 hours = 4.5 seconds$$

Similarly T3 can be calculated.

Solving T2 and T4:
State variable: number of passengers−no. of bags/trays
Consider bag capacity=m
Passenger capacity=N
Passenger arrival=λ
Bag arrival=μ

The system may consider these general variables now in order to later solve for the actual values of the system.

FIG. 4D is a flow diagram 400d illustrating projecting a level of needed airport support services using the system of FIG. 1 in accordance with exemplary embodiments.

Sub-system 400d represents matching passengers and baggage. State space representation with respect to the variable concerned is given below.

The rate balance equations may comprise:

$$π ( - m ) λ = π ( - ( m - 1 ) ) μ$$

$$π ( - ( m - 1 ) ) ( λ + μ ) = π ( - m ) λ + π ( - ( m - 2 ) ) μ$$

$$π ( - ( m - 2 ) ) ( λ + μ ) = π ( - ( m - 1 ) ) λ + π ( - ( m - 3 ) ) μ$$

$$π ( - ( m - k ) ) = ( \frac{{λ}^{k}}{{μ}^{k}} ) π ( - m )$$

$$\sum π ( x ) = 1$$

$$π ( - m ) = ( 1 - \frac{λ}{μ} ) / ( 1 - {( \frac{λ}{μ} )}^{m + N - 1} )$$

Average no. of passengers in the sub-system:

$$Lp = {\sum }_{1}^{N} x π ( x ) = \frac{{u}^{m + 1}}{1 - {u}^{m + N - 1}} * \frac{1 - ( N + 1 ) {u}^{N} + {Nu}^{N + 1}}{1 - u}$$

$$where u = λ / μ$$

Average no. of bags in the sub-system:

$$Lb = {\sum }_{1}^{m} x π ( - x ) = ( m ( 1 - {u}^{m} ) - \frac{u ( 1 - {mu}^{m - 1} + ( m - 1 ) {u}^{m} )}{1 - u} ) * \frac{1}{1 - {u}^{m + N - 1}}$$

By substituting the actual input values, the solutions for T4 and T2 are:

For m=8, N=∝, λ=225, μ=306, i.e, u=0.735

Lp=0.236, T4=Lp/λ=0.00105 hours=3.7 seconds

Lb=5.46, T2=Lb/λ=0.02 hours=72 seconds

Therefore, Tb=z1+T1+z2+T2=206 seconds; Tp=T3+T4=15.69 seconds, implying current residence time=206 seconds=3.4 minutes.

Thus, in an exemplary embodiment, it requires on an average 3.4 minutes of total time for a passenger for check in with three servers. Similarly, a similar time may be calculated for different number of servers in order to calculate the benefit on an increase in servers.

FIG. 4E is a flow diagram 400e illustrating projecting a level of needed airport support services using the system of FIG. 1 in accordance with exemplary embodiments. Projecting a level of needed airport support services may also be utilized in calculating and/or predicting demand for airport parking. Long-term airport parking sites exist practically at all commercial airports in the world. Currently, companies that operate these sites do not have a very good way to predict demand, market to target consumers, and/or adjust price based on predicted demand to help sell out their inventory, thus maximizing profits. Many airport parking services use flat daily rates with occasional discounts offered through promotions/coupons.

By using transactional data collected by the system, and addendum data about upcoming trips, the system may predict the likelihood of each traveler to use long-term airport parking while they are away on a trip. The data is then aggregated to predict the overall daily and weekly demand. Parking companies can use this information to vary their prices based on upcoming demand as trips get booked and also market to potential consumers.

In step 402e, new airline transaction for a future travel may be input into the system and saved in one or more of the system's databases (e.g., information about length of the trip, destination, class of service, number of tickets purchased etc.).

In step 404e, other travel related transactions (e.g., hotel, car rental, cruise, etc.) may be determined for the current transaction.

In step 406e, inferences may be determined about the type of trip (e.g., business trip, family vacation, weekend getaway etc.).

In step 408e, the consumer residential zip code may be identified and stored in the databases (e.g., identify local consumers who live within “sweet spot” areas where it is economical to park at an origin airport vs. taking a taxi).

In step 410e, long term airport parking, car service, and airport shuttle transactions utilized by the consumer in the past may be determined by detecting consumer preferences and measuring the propensity to spend in the long term airport parking category in the future.

In step 412e, consumers may be segmented based on preferences, propensity to buy long term parking and upcoming trip types.

In step 414e, the scores for each consumer may be aggregated to estimate daily demand levels.

### Exemplary Method for Generating Data Correlations Between Parking Metrics and Transaction Behavior

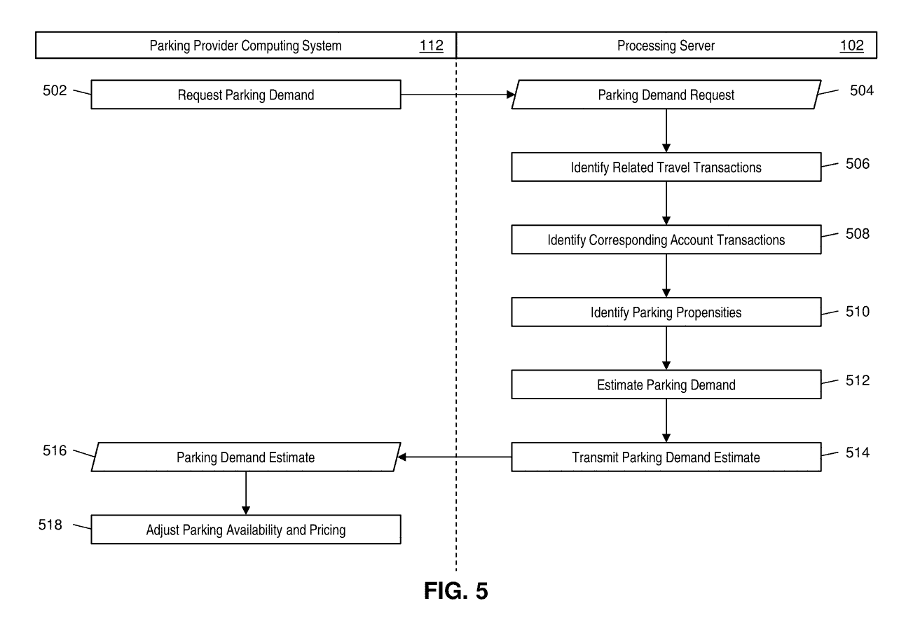

FIG. 5 is a flow diagram 500 illustrating projecting a level of needed airport support services using the system of FIG. 1 in accordance with exemplary embodiments.

In step 502, the parking card provider computing system 112 may request parking demand from the processing server 102. In step 504, the processing server 112 may receive the parking demand request. In step 506, the processing server 112 may identify related travel transactions. In step 508, the processing server 112 may identify corresponding account transactions. In step 510, the processing server 112 may identify parking propensities. In step 512, the processing server 112 may estimate parking demand. In step 514, the processing server 112 may transmit a parking demand estimate. In step 502, the parking card provider computing system 112 may receive the parking demand estimate. In step 502, the parking card provider computing system 112 may adjust parking availability and pricing.

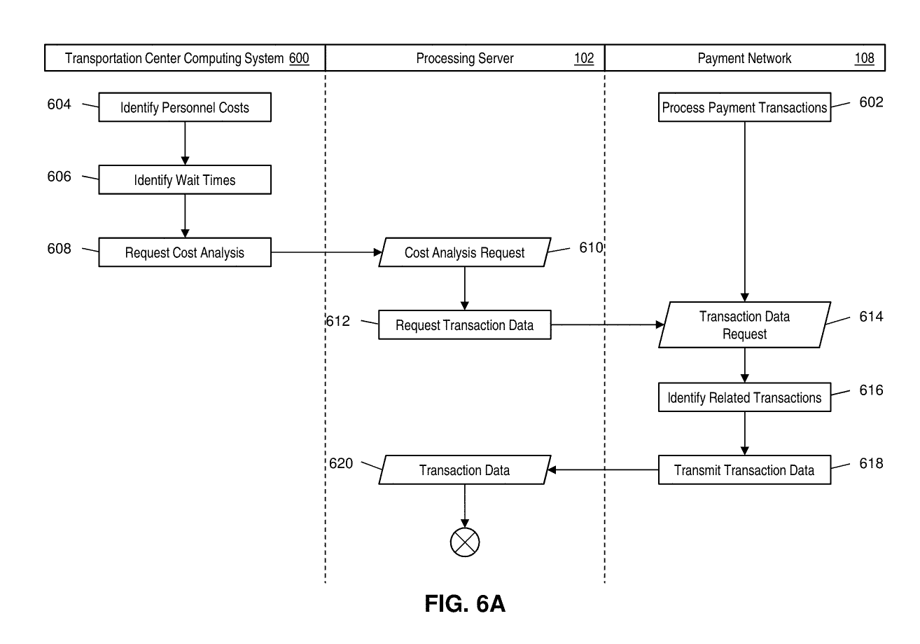

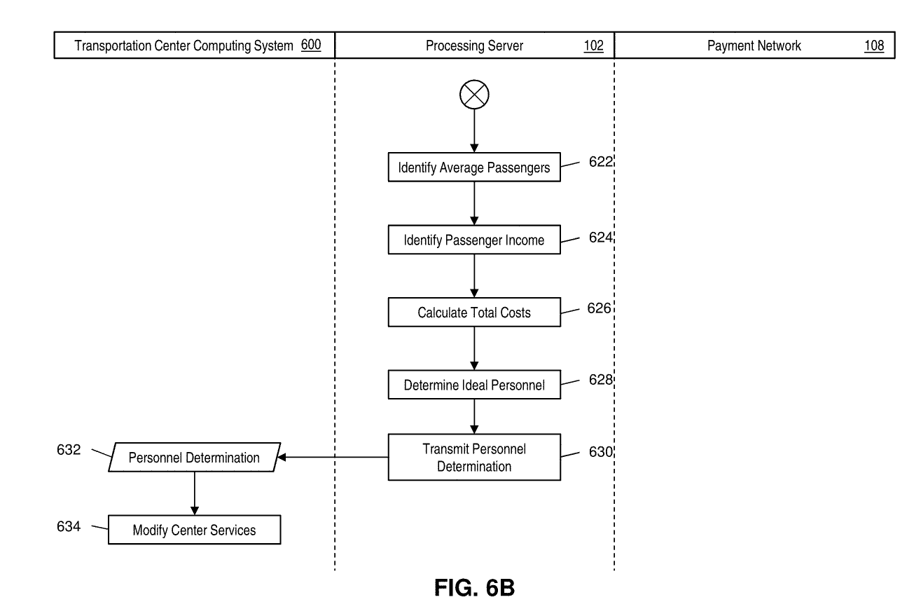

FIG. 6A is a flow diagram illustrating projecting a level of needed airport support services using the system of FIG. 1 in accordance with exemplary embodiments.

In step 602, the payment network 108 may process payment transactions. In step 604, the transportation center computing system 600 may identify personnel costs. In step 606, the transportation center computing system 600 may identify wait times. In step 608, the transportation center computing system 600 may request cost analysis. In step 610, the processing server 102 may receive a cost analysis request. In step 612, the processing server 102 may request transaction data.

In step 614, the payment network 108 may receive the transaction data request. In step 616, the payment network 108 may identify related transactions. In step 618, the payment network 108 may transmit related transactions. In step 620, the processing server 102 may receive transaction data.

FIG. 6B is a flow diagram illustrating projecting a level of needed airport support services using the system of FIG. 1 in accordance with exemplary embodiments.

In step 622, the processing server 102 may identify average number of passengers. In step 624, the processing server 102 may identify passenger income. In step 626, the processing server 102 may calculate total costs. In step 628, the processing server 102 may determine the ideal number of personnel. In step 630, the processing server 102 may transmit personnel number determination. In step 632, the transportation center computing system may receive the personnel number determination. In step 634, the transportation center computing system may modify center services.

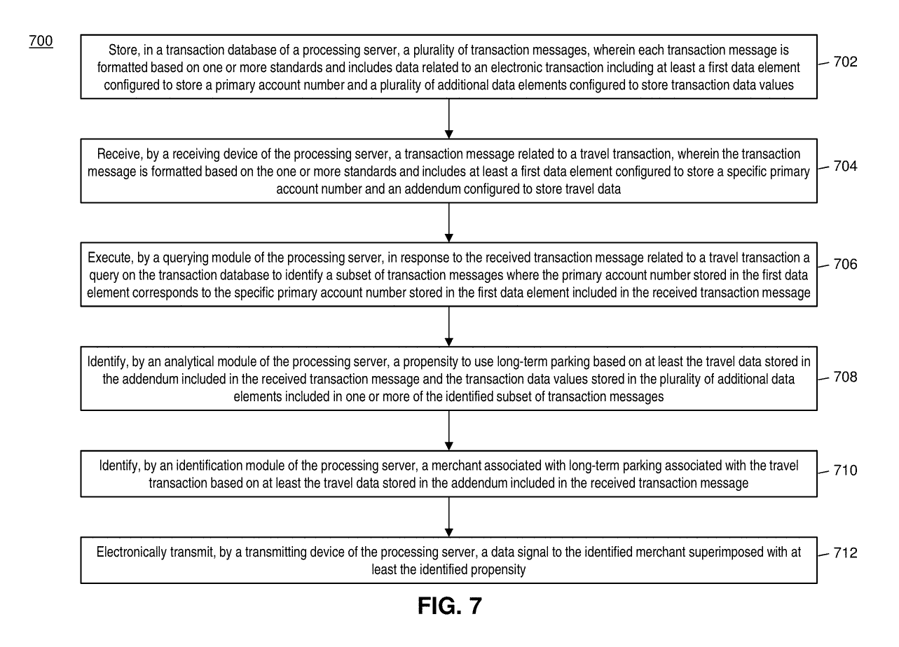

FIG. 7 is a flow chart illustrating projecting a level of needed airport support services using the system of FIG. 1 in accordance with exemplary embodiments.

In step 702, a transaction database (e.g., transaction database 206) of a processing server (e.g., processing server 102) may store a plurality of transaction messages, wherein each transaction message may be formatted based on one or more standards and includes data related to an electronic transaction including at least a first data element configured to store a primary account number and a plurality of additional data elements configured to store transaction data values.

In step 704, a receiving device (e.g., receiving device 202) of the processing server (e.g., processing server 102) may receive a transaction message related to a travel transaction, wherein the transaction message may be formatted based on the one or more standards and includes at least a first data element configured to store a specific primary account number and an addendum configured to store travel data.

In step 706, a querying module (e.g., querying module 218) of the processing server (e.g., processing server 102) may execute, in response to the received transaction message related to a travel transaction, a query on the transaction database to identify a subset of transaction messages where the primary account number stored in the first data element corresponds to the specific primary account number stored in the first data element included in the received transaction message.

In step 708, an analytical module (e.g., analytic module 220) of the processing server (e.g., processing server 102) may identify a propensity to use long-term parking based on at least the travel data stored in the addendum included in the received transaction message and the transaction data values stored in the plurality of additional data elements included in one or more of the identified subset of transaction messages.

In step 710, an identification module (e.g., identification module 222) of the processing server (e.g., processing server 102) may identify a merchant associated with long-term parking associated with the travel transaction based on at least the travel data stored in the addendum included in the received transaction message.

In step 712, a transmitting device (e.g., transmitting device 230) of the processing server (e.g., processing server 102) may electronically transmit a data signal to the identified merchant superimposed with at least the identified propensity.

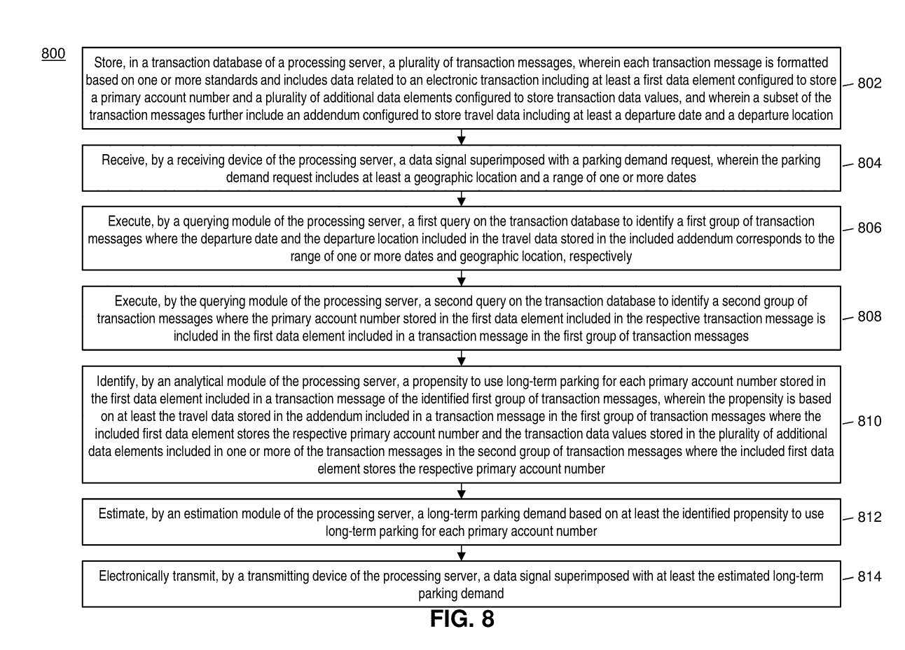

FIG. 8 is a flow chart illustrating projecting a level of needed airport support services using the system of FIG. 1 in accordance with exemplary embodiments.

In step 802, a transaction database (e.g., transaction database 206) of a processing server (e.g., processing server 102) may store a plurality of transaction messages, wherein each transaction message is formatted based on one or more standards and includes data related to an electronic transaction including at least a first data element configured to store a primary account number and a plurality of additional data elements configured to store transaction data values, and wherein a subset of the transaction messages further include an addendum configured to store travel data including at least a departure date and a departure location.

In step 804, a receiving device (e.g., receiving device 202) of the processing server (e.g., processing server 102) may receive a data signal superimposed with a parking demand request, wherein the parking demand request includes at least a geographic location and a range of one or more dates.

In step 806, a querying module (e.g., querying module 218) of the processing server (e.g., processing server 102) may execute a first query on the transaction database to identify a first group of transaction messages where the departure date and the departure location included in the travel data stored in the included addendum corresponds to the range of one or more dates and geographic location, respectively.

In step 808, the querying module (e.g., querying module 218) of the processing server (e.g., processing server 102) may execute a second query on the transaction database to identify a second group of transaction messages where the primary account number stored in the first data element included in the respective transaction message is included in the first data element included in a transaction message in the first group of transaction messages.

In step 810, an analytical module (e.g., analytic module 220) of the processing server (e.g., processing server 102) may identify a propensity to use long-term parking for each primary account number stored in the first data element included in a transaction message of the identified first group of transaction messages, wherein the propensity is based on at least the travel data stored in the addendum included in a transaction message in the first group of transaction messages where the included first data element stores the respective primary account number and the transaction data values stored in the plurality of additional data elements included in one or more of the transaction messages in the second group of transaction messages where the included first data element stores the respective primary account number.

In step 812, an estimation module (e.g., estimation module 224) of the processing server (e.g., processing server 102) may estimate a long-term parking demand based on at least the identified propensity to use long-term parking for each primary account number.

In step 814, a transmitting device (e.g., transmitting device 230) of the processing server (e.g., processing server 102) may electronically transmit a data signal superimposed with at least the estimated long-term parking demand.

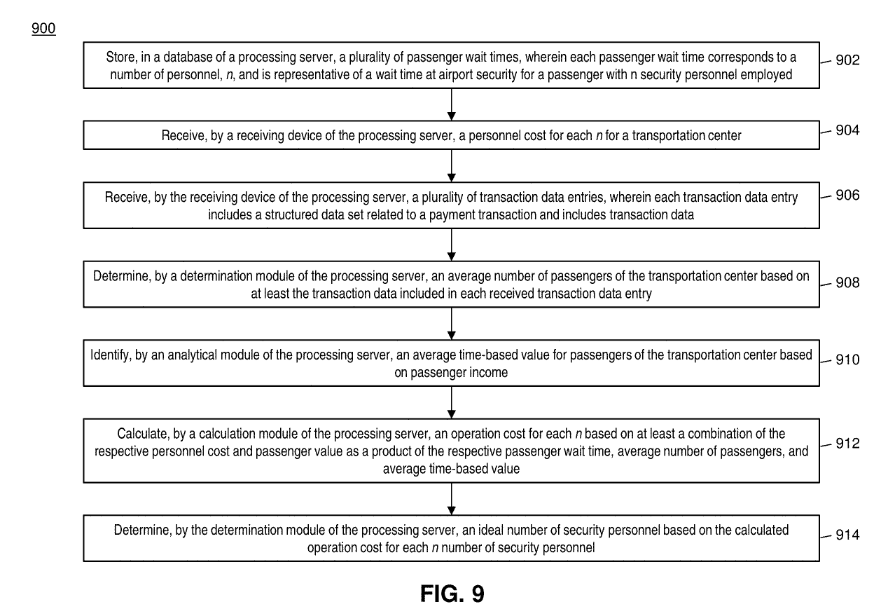

FIG. 9 is a flow chart illustrating projecting a level of needed airport support services using the system of FIG. 1 in accordance with exemplary embodiments.

In step 902, a database (e.g., transaction database 206, account database 210, and/or merchant database 214) of a processing server (e.g., processing server 102) may store a plurality of passenger wait times, wherein each passenger wait time corresponds to a number of personnel, n, and is representative of a wait time at airport security for a passenger with n security personnel employed.

In step 904, a receiving device (e.g., receiving device 202) of the processing server (e.g., processing server 102) may receive a personnel cost for each n for a transportation center.

In step 906, the receiving device (e.g., receiving device 202) of the processing server (e.g., processing server 102) may receive a plurality of transaction data entries, wherein each transaction data entry includes a structured data set related to a payment transaction and includes transaction data.

In step 908, a determination module (e.g., determination module 228) of the processing server (e.g., processing server 102) may determine an average number of passengers of the transportation center based on at least the transaction data included in each received transaction data entry.

In step 910, an analytical module (e.g., analytic module 220) of the processing server (e.g., processing server 102) may identify an average time-based value for passengers of the transportation center based on passenger income.

In step 912, a calculation module (e.g., calculation module 226) of the processing server (e.g., processing server 102) may calculate an operation cost for each n based on at least a combination of the respective personnel cost and passenger value as a product of the respective passenger wait time, average number of passengers, and average time-based value.

In step 914, the determination module (e.g., determination module 228) of the processing server (e.g., processing server 102) may determine an ideal number of security personnel based on the calculated operation cost for each n number of security personnel.

### Payment Transaction Processing System and Process

FIG. 10 is a flow diagram 1000 illustrating the processing of a payment transaction in accordance with exemplary embodiments.

The process 1000 and steps included therein may be performed by one or more components of the system 100 discussed above, such as the processing server 102, merchants 104, payment network 108, etc. The processing of payment transactions using the system and process 1000 illustrated in FIGS. 3-9 and discussed below may utilize the payment rails, which may be comprised of the computing devices and infrastructure utilized to perform the steps of the process 1000 as specially configured and programmed by the entities discussed below, including the transaction processing server 1012, which may be associated with one or more payment networks configured to processing payment transactions. It will be apparent to persons having skill in the relevant art that the process 1000 may be incorporated into the processes illustrated in FIGS. 3-9, discussed above, with respect to the step or steps involved in the processing of a payment transaction. In addition, the entities discussed herein for performing the process 1000 may include one or more computing devices or systems configured to perform the functions discussed below. For instance, the merchant 1006 may be comprised of one or more point of sale devices, a local communication network, a computing server, and other devices configured to perform the functions discussed below.

In step 1020, an issuing financial institution 1002 may issue a payment card or other suitable payment instrument to a consumer 1004. The issuing financial institution may be a financial institution, such as a bank, or other suitable type of entity that administers and manages payment accounts and/or payment instruments for use with payment accounts that can be used to fund payment transactions. The consumer 1004 may have a transaction account with the issuing financial institution 1002 for which the issued payment card is associated, such that, when used in a payment transaction, the payment transaction is funded by the associated transaction account. In some embodiments, the payment card may be issued to the consumer 1004 physically. In other embodiments, the payment card may be a virtual payment card or otherwise provisioned to the consumer 1004 in an electronic format.

In step 1022, the consumer 1004 may present the issued payment card to a merchant 1006 for use in funding a payment transaction. The merchant 1006 may be a business, another consumer, or any entity that may engage in a payment transaction with the consumer 1004. The payment card may be presented by the consumer 1004 via providing the physical card to the merchant 1006, electronically transmitting (e.g., via near field communication, wireless transmission, or other suitable electronic transmission type and protocol) payment details for the payment card, or initiating transmission of payment details to the merchant 1006 via a third party. The merchant 1006 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 1024, the merchant 1006 may enter transaction details into a point of sale computing system. The transaction details may include the payment details provided by the consumer 1004 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 1006 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 1006 may be an online retailer in an e-commerce transaction. In such embodiments, the transaction details may be entered in a shopping cart or other repository for storing transaction data in an electronic transaction as will be apparent to persons having skill in the relevant art.

In step 1026, the merchant 1006 may electronically transmit a data signal superimposed with transaction data to a gateway processor 1008. The gateway processor 1008 may be an entity configured to receive transaction details from a merchant 1006 for formatting and transmission to an acquiring financial institution 1010. In some instances, a gateway processor 1008 may be associated with a plurality of merchants 1006 and a plurality of acquiring financial institutions 1010. In such instances, the gateway processor 1008 may receive transaction details for a plurality of different transactions involving various merchants, which may be forwarded on to appropriate acquiring financial institutions 1010. By having relationships with multiple acquiring financial institutions 1010 and having the requisite infrastructure to communicate with financial institutions using the payment rails, such as using application programming interfaces associated with the gateway processor 1008 or financial institutions used for the submission, receipt, and retrieval of data, a gateway processor 1008 may act as an intermediary for a merchant 1006 to be able to conduct payment transactions via a single communication channel and format with the gateway processor 1008, without having to maintain relationships with multiple acquiring financial institutions 1010 and payment processors and the hardware associated thereto. Acquiring financial institutions 1010 may be financial institutions, such as banks, or other entities that administers and manages payment accounts and/or payment instruments for use with payment accounts. In some instances, acquiring financial institutions 1010 may manage transaction accounts for merchants 1006. In some cases, a single financial institution may operate as both an issuing financial institution 1002 and an acquiring financial institution 1010.

The data signal transmitted from the merchant 1006 to the gateway processor 1008 may be superimposed with the transaction details for the payment transaction, which may be formatted based on one or more standards. In some embodiments, the standards may be set forth by the gateway processor 1008, which may use a unique, proprietary format for the transmission of transaction data to/from the gateway processor 1008. In other embodiments, a public standard may be used, such as the International Organization for Standardization's ISO 8783 standard. The standard may indicate the types of data that may be included, the formatting of the data, how the data is to be stored and transmitted, and other criteria for the transmission of the transaction data to the gateway processor 1008.

In step 1028, the gateway processor 1008 may parse the transaction data signal to obtain the transaction data superimposed thereon and may format the transaction data as necessary. The formatting of the transaction data may be performed by the gateway processor 1008 based on the proprietary standards of the gateway processor 1008 or an acquiring financial institution 1010 associated with the payment transaction. The proprietary standards may specify the type of data included in the transaction data and the format for storage and transmission of the data. The acquiring financial institution 1010 may be identified by the gateway processor 1008 using the transaction data, such as by parsing the transaction data (e.g., deconstructing into data elements) to obtain an account identifier included therein associated with the acquiring financial institution 1010. In some instances, the gateway processor 1008 may then format the transaction data based on the identified acquiring financial institution 1010, such as to comply with standards of formatting specified by the acquiring financial institution 1010. In some embodiments, the identified acquiring financial institution 1010 may be associated with the merchant 1006 involved in the payment transaction, and, in some cases, may manage a transaction account associated with the merchant 1006.

In step 1030, the gateway processor 1008 may electronically transmit a data signal superimposed with the formatted transaction data to the identified acquiring financial institution 1010. The acquiring financial institution 1010 may receive the data signal and parse the signal to obtain the formatted transaction data superimposed thereon. In step 1032, the acquiring financial institution may generate an authorization request for the payment transaction based on the formatted transaction data. The authorization request may be a specially formatted transaction message that is formatted pursuant to one or more standards, such as the ISO 8783 standard and standards set forth by a payment processor used to process the payment transaction, such as a payment network. The authorization request may be a transaction message that includes a message type indicator indicative of an authorization request, which may indicate that the merchant 1006 involved in the payment transaction is requesting payment or a promise of payment from the issuing financial institution 1002 for the transaction. The authorization request may include a plurality of data elements, each data element being configured to store data as set forth in the associated standards, such as for storing an account number, application cryptogram, transaction amount, issuing financial institution 1002 information, etc.

In step 1034, the acquiring financial institution 1010 may electronically transmit the authorization request to a transaction processing server 1012 for processing. The transaction processing server 1012 may be comprised of one or more computing devices as part of a payment network configured to process payment transactions. In some embodiments, the authorization request may be transmitted by a transaction processor at the acquiring financial institution 1010 or other entity associated with the acquiring financial institution. The transaction processor may be one or more computing devices that include a plurality of communication channels for communication with the transaction processing server 1012 for the transmission of transaction messages and other data to and from the transaction processing server 1012. In some embodiments, the payment network associated with the transaction processing server 1012 may own or operate each transaction processor such that the payment network may maintain control over the communication of transaction messages to and from the transaction processing server 1012 for network and informational security.

In step 1036, the transaction processing server 1012 may perform value-added services for the payment transaction. Value-added services may be services specified by the issuing financial institution 1002 that may provide additional value to the issuing financial institution 1002 or the consumer 1004 in the processing of payment transactions. Value-added services may include, for example, fraud scoring, transaction or account controls, account number mapping, offer redemption, loyalty processing, etc. For instance, when the transaction processing server 1012 receives the transaction, a fraud score for the transaction may be calculated based on the data included therein and one or more fraud scoring algorithms and/or engines. In some instances, the transaction processing server 1012 may first identify the issuing financial institution 1002 associated with the transaction, and then identify any services indicated by the issuing financial institution 1002 to be performed. The issuing financial institution 1002 may be identified, for example, by data included in a specific data element included in the authorization request, such as an issuer identification number. In another example, the issuing financial institution 1002 may be identified by the primary account number stored in the authorization request, such as by using a portion of the primary account number (e.g., a bank identification number) for identification.

In step 1038, the transaction processing server 1012 may electronically transmit the authorization request to the issuing financial institution 1002. In some instances, the authorization request may be modified, or additional data included in or transmitted accompanying the authorization request as a result of the performance of value-added services by the transaction processing server 1012. In some embodiments, the authorization request may be transmitted to a transaction processor (e.g., owned or operated by the transaction processing server 1012) situated at the issuing financial institution 1002 or an entity associated thereof, which may forward the authorization request to the issuing financial institution 1002.

In step 1040, the issuing financial institution 1002 may authorize the transaction account for payment of the payment transaction. The authorization may be based on an available credit amount for the transaction account and the transaction amount for the payment transaction, fraud scores provided by the transaction processing server 1012, and other considerations that will be apparent to persons having skill in the relevant art. The issuing financial institution 1002 may modify the authorization request to include a response code indicating approval (e.g., or denial if the transaction is to be denied) of the payment transaction. The issuing financial institution 1002 may also modify a message type indicator for the transaction message to indicate that the transaction message is changed to be an authorization response. In step 1042, the issuing financial institution 1002 may transmit (e.g., via a transaction processor) the authorization response to the transaction processing server 1012.

In step 1044, the transaction processing server 1012 may forward the authorization response to the acquiring financial institution 1010 (e.g., via a transaction processor). In step 1046, the acquiring financial institution may generate a response message indicating approval or denial of the payment transaction as indicated in the response code of the authorization response, and may transmit the response message to the gateway processor 1008 using the standards and protocols set forth by the gateway processor 1008. In step 1048, the gateway processor 1008 may forward the response message to the merchant 1006 using the appropriate standards and protocols. In step 1070, the merchant 1006 may then provide the products purchased by the consumer 1004 as part of the payment transaction to the consumer 1004.

In some embodiments, once the process 1000 has completed, payment from the issuing financial institution 1002 to the acquiring financial institution 1010 may be performed. In some instances, the payment may be made immediately or within one business day. In other instances, the payment may be made after a period of time, and in response to the submission of a clearing request from the acquiring financial institution 1010 to the issuing financial institution 1002 via the transaction processing server 1002. In such instances, clearing requests for multiple payment transactions may be aggregated into a single clearing request, which may be used by the transaction processing server 1012 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 1040), the transaction processing server 1012 may be configured to perform authorization of transactions on behalf of the issuing financial institution 1002. Such actions may be referred to as “stand-in processing,” where the transaction processing server “stands in” as the issuing financial institution 1002. In such instances, the transaction processing server 1012 may utilize rules set forth by the issuing financial institution 1002 to determine approval or denial of the payment transaction, and may modify the transaction message accordingly prior to forwarding to the acquiring financial institution 1010 in step 1044. The transaction processing server 1012 may retain data associated with transactions for which the transaction processing server 1012 stands in, and may transmit the retained data to the issuing financial institution 1002 once communication is reestablished. The issuing financial institution 1002 may then process transaction accounts accordingly to accommodate for the time of lost communication.

In another example, if the transaction processing server 1012 is unavailable for submission of the authorization request by the acquiring financial institution 1010, then the transaction processor at the acquiring financial institution 1010 may be configured to perform the processing of the transaction processing server 1012 and the issuing financial institution 1002. The transaction processor may include rules and data suitable for use in making a determination of approval or denial of the payment transaction based on the data included therein. For instance, the issuing financial institution 1002 and/or transaction processing server 1012 may set limits on transaction type, transaction amount, etc. that may be stored in the transaction processor and used to determine approval or denial of a payment transaction based thereon. In such instances, the acquiring financial institution 1010 may receive an authorization response for the payment transaction even if the transaction processing server 1012 is unavailable, ensuring that transactions are processed and no downtime is experienced even in instances where communication is unavailable. In such cases, the transaction processor may store transaction details for the payment transactions, which may be transmitted to the transaction processing server 1012 (e.g., and from there to the associated issuing financial institutions 1002) once communication is reestablished.

In some embodiments, transaction processors may be configured to include a plurality of different communication channels, which may utilize multiple communication cards and/or devices, to communicate with the transaction processing server 1012 for the sending and receiving of transaction messages. For example, a transaction processor may be comprised of multiple computing devices, each having multiple communication ports that are connected to the transaction processing server 1012. In such embodiments, the transaction processor may cycle through the communication channels when transmitting transaction messages to the transaction processing server 1012, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 1010 may identify that an authorization request involves an issuing financial institution 1002 (e.g., via the bank identification number included in the transaction message) for which no value-added services are required. The transaction processor at the acquiring financial institution 1010 may then transmit the authorization request directly to the transaction processor at the issuing financial institution 1002 (e.g., without the authorization request passing through the transaction processing server 1012), where the issuing financial institution 1002 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 1012 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 1008, acquiring financial institution 1010, etc.) for processing using this advanced network, and to quickly and efficiently receive a response regarding the ability for a consumer 1004 to fund the payment transaction.

### Computer System Architecture

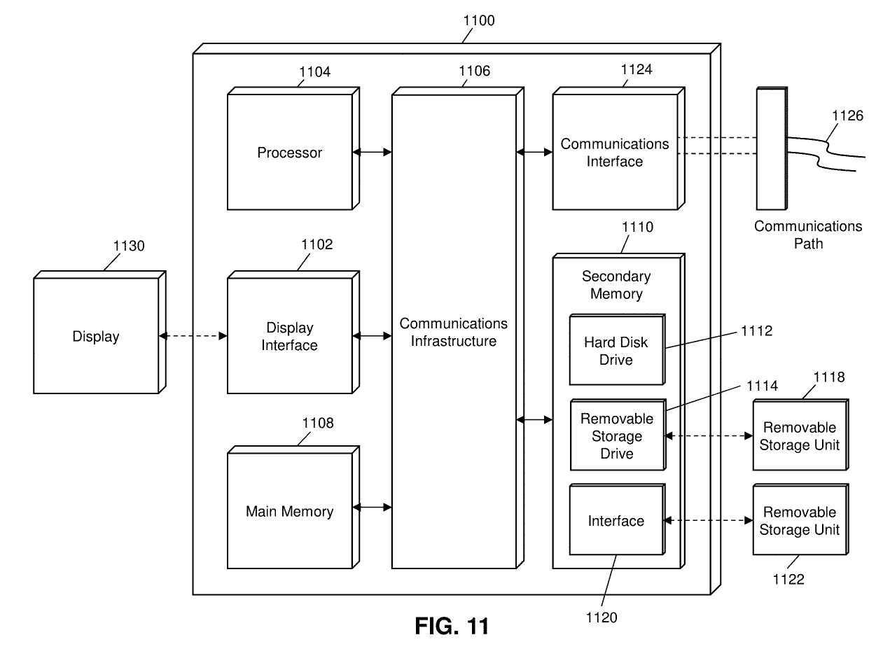

FIG. 11 is a diagram 1100 illustrating a computer system architecture in accordance with exemplary embodiments.

For example, the processing server 102 of FIG. 1 may be implemented in the computer system 1100 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1118, a removable storage unit 1122, and a hard disk installed in hard disk drive 1112.

Various embodiments of the present disclosure are described in terms of this example computer system 1100. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1104 may be a special purpose or a general purpose processor device specifically configured to perform the functions discussed herein. The processor device 1104 may be connected to a communications infrastructure 1106, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1100 may also include a main memory 1108 (e.g., random access memory, read-only memory, etc.), and may also include a secondary memory 1110. The secondary memory 1110 may include the hard disk drive 1112 and a removable storage drive 1114, such as a floppy disk drive, a magnetic tape drive, an optical disk drive, a flash memory, etc.

The removable storage drive 1114 may read from and/or write to the removable storage unit 1118 in a well-known manner. The removable storage unit 1118 may include a removable storage media that may be read by and written to by the removable storage drive 1114. For example, if the removable storage drive 1114 is a floppy disk drive or universal serial bus port, the removable storage unit 1118 may be a floppy disk or portable flash drive, respectively. In one embodiment, the removable storage unit 1118 may be non-transitory computer readable recording media.

In some embodiments, the secondary memory 1110 may include alternative means for allowing computer programs or other instructions to be loaded into the computer system 1100, for example, the removable storage unit 1122 and an interface 1120. Examples of such means may include a program cartridge and cartridge interface (e.g., as found in video game systems), a removable memory chip (e.g., EEPROM, PROM, etc.) and associated socket, and other removable storage units 1122 and interfaces 1120 as will be apparent to persons having skill in the relevant art.

Data stored in the computer system 1100 (e.g., in the main memory 1108 and/or the secondary memory 1110) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1100 may also include a communications interface 1124. The communications interface 1124 may be configured to allow software and data to be transferred between the computer system 1100 and external devices. Exemplary communications interfaces 1124 may include a modem, a network interface (e.g., an Ethernet card), a communications port, a PCMCIA slot and card, etc. Software and data transferred via the communications interface 1124 may be in the form of signals, which may be electronic, electromagnetic, optical, or other signals as will be apparent to persons having skill in the relevant art. The signals may travel via a communications path 1126, which may be configured to carry the signals and may be implemented using wire, cable, fiber optics, a phone line, a cellular phone link, a radio frequency link, etc.

The computer system 1100 may further include a display interface 1102. The display interface 1102 may be configured to allow data to be transferred between the computer system 1100 and external display 1130. Exemplary display interfaces 1102 may include high-definition multimedia interface (HDMI), digital visual interface (DVI), video graphics array (VGA), etc. The display 1130 may be any suitable type of display for displaying data transmitted via the display interface 1102 of the computer system 1100, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1108 and secondary memory 1110, which may be memory semiconductors (e.g., DRAMs, etc.). These computer program products may be means for providing software to the computer system 1100. Computer programs (e.g., computer control logic) may be stored in the main memory 1108 and/or the secondary memory 1110. Computer programs may also be received via the communications interface 1124. Such computer programs, when executed, may enable computer system 1100 to implement the present methods as discussed herein. In particular, the computer programs, when executed, may enable processor device 1104 to implement the methods illustrated by FIGS. 3-9, as discussed herein. Accordingly, such computer programs may represent controllers of the computer system 1100. Where the present disclosure is implemented using software, the software may be stored in a computer program product and loaded into the computer system 1100 using the removable storage drive 1114, interface 1120, and hard disk drive 1112, or communications interface 1124.

The processor device 1104 may comprise one or more modules or engines configured to perform the functions of the computer system 1100. Each of the modules or engines may be implemented using hardware and, in some instances, may also utilize software, such as corresponding to program code and/or programs stored in the main memory 1108 or secondary memory 1110. In such instances, program code may be compiled by the processor device 1104 (e.g., by a compiling module or engine) prior to execution by the hardware of the computer system 1100. For example, the program code may be source code written in a programming language that is translated into a lower level language, such as assembly language or machine code, for execution by the processor device 1104 and/or any additional hardware components of the computer system 1100. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 1100 to perform the functions disclosed herein. It will be apparent to persons having skill in the relevant art that such processes result in the computer system 1100 being a specially configured computer system 1100 uniquely programmed to perform the functions discussed above.

Techniques consistent with the present disclosure provide, among other features, systems and methods for generating and using indexing models for neighborhood growth. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for estimating individual propensity to use airport support services, comprising:
storing, in a transaction database of a processing server, a plurality of transaction messages, wherein each transaction message is formatted based on one or more standards and includes data related to an electronic transaction including at least a first data element configured to store a primary account number and a plurality of additional data elements configured to store transaction data values;
receiving, by a receiving device of the processing server, a transaction message related to a travel transaction, wherein the transaction message is formatted based on the one or more standards and includes at least a first data element configured to store a specific primary account number and an addendum configured to store travel data;
executing, by a querying module of the processing server, in response to the received transaction message related to a travel transaction a query on the transaction database to identify a subset of transaction messages where the primary account number stored in the first data element corresponds to the specific primary account number stored in the first data element included in the received transaction message related to a travel transaction;
identifying, by an analytical module of the processing server, a projected level of needed airport support services propensity to use long-term parking based on at least the travel data stored in the addendum included in the received transaction message and the transaction data values stored in the plurality of additional data elements included in one or more of the identified subset of transaction messages;
identifying, by an identification module of the processing server, an entity associated with needed airport support services associated with the travel transaction based on at least the travel data stored in the addendum included in the received transaction message; and
electronically transmitting, by a transmitting device of the processing server, a data signal to the identified entity superimposed with at least the identified projected level of needed support services.

2. The method of claim 1, wherein the travel data includes at least one of: departure airport, arrival airport, date of departure, date of arrival, time of departure, time of arrival, and length of travel.

3. The method of claim 1, wherein the transaction data values include at least one of: transaction time, transaction date, transaction amount, merchant category, merchant name, geographic location, merchant data, and product data.

4. The method of claim 1, wherein
at least one of the transaction message included in the identified subset of transaction messages includes an addendum configured to store travel information, and
the identified propensity is further based on the travel information stored in the addendum included in the at least one transaction message.

5. The method of claim 4, wherein the identified propensity is further based on one or more transaction messages related to the at least one transaction message where a merchant category included in the transaction data values stored in the included plurality of additional data elements is representative of a parking, rental car, or transportation merchant.

6. A method for estimating demand of long-term parking, comprising:
storing, in a transaction database of a processing server, a plurality of transaction messages, wherein each transaction message is formatted based on one or more standards and includes data related to an electronic transaction including at least a first data element configured to store a primary account number and a plurality of additional data elements configured to store transaction data values, and wherein a subset of the transaction messages further include an addendum configured to store travel data including at least a departure date and a departure location;
receiving, by a receiving device of the processing server, a data signal superimposed with a parking demand request, wherein the parking demand request includes at least a geographic location and a range of one or more dates;
executing, by a querying module of the processing server, a first query on the transaction database to identify a first group of transaction messages where the departure date and the departure location included in the travel data stored in the included addendum corresponds to the range of one or more dates and geographic location, respectively;
executing, by the querying module of the processing server, a second query on the transaction database to identify a second group of transaction messages where the primary account number stored in the first data element included in the respective transaction message is included in the first data element included in a transaction message in the first group of transaction messages;
identifying, by an analytical module of the processing server, a propensity to use long-term parking for each primary account number stored in the first data element included in a transaction message of the identified first group of transaction messages, wherein the propensity is based on at least the travel data stored in the addendum included in a transaction message in the first group of transaction messages where the included first data element stores the respective primary account number and the transaction data values stored in the plurality of additional data elements included in one or more of the transaction messages in the second group of transaction messages where the included first data element stores the respective primary account number;
estimating, by an estimation module of the processing server, a long-term parking demand based on at least the identified propensity to use long-term parking for each primary account number; and
electronically transmitting, by a transmitting device of the processing server, a data signal superimposed with at least the estimated long-term parking demand.

7. The method of claim 6, wherein the travel data further includes at least one of: departure airport, arrival airport, date of arrival, time of departure, time of arrival, and length of travel.

8. The method of claim 6, wherein the transaction data values include at least one of: transaction time, transaction date, transaction amount, merchant category, merchant name, geographic location, merchant data, and product data.

9. The method of claim 6, wherein the identified propensity is further based on a transaction messages in the one or more transaction messages in the second group where a merchant category included in the transaction data values stored in the included plurality of additional data elements is representative of a parking, rental car, or transportation merchant.

10. The method of claim 6, wherein
the parking demand request further includes one or more parking capacities, and
the estimated long-term parking demand is further based on the one or more parking capacities.

11. A system for estimating individual propensity to use airport support services, comprising:
a transaction database of a processing server configured to store a plurality of transaction messages, wherein each transaction message is formatted based on one or more standards and includes data related to an electronic transaction including at least a first data element configured to store a primary account number and a plurality of additional data elements configured to store transaction data values;
a receiving device of the processing server configured to receive a transaction message related to a travel transaction, wherein the transaction message is formatted based on the one or more standards and includes at least a first data element configured to store a specific primary account number and an addendum configured to store travel data;
a querying module of the processing server configured to execute in response to the received transaction message related to a travel transaction a query on the transaction database to identify a subset of transaction messages where the primary account number stored in the first data element corresponds to the specific primary account number stored in the first data element included in the received transaction message related to a travel transaction;
an analytical module of the processing server configured to identify a projected level of needed airport support services propensity to use long-term parking based on at least the travel data stored in the addendum included in the received transaction message and the transaction data values stored in the plurality of additional data elements included in one or more of the identified subset of transaction messages;
an identification module of the processing server configured to identify an entity associated with needed airport support services associated with the travel transaction based on at least the travel data stored in the addendum included in the received transaction message; and
a transmitting device of the processing server configured to electronically transmit a data signal to the identified entity superimposed with at least the identified projected level of needed support services.

12. The system of claim 11, wherein the travel data includes at least one of: departure airport, arrival airport, date of departure, date of arrival, time of departure, time of arrival, and length of travel.

13. The system of claim 11, wherein the transaction data values include at least one of: transaction time, transaction date, transaction amount, merchant category, merchant name, geographic location, merchant data, and product data.

14. The system of claim 11, wherein
at least one of the transaction message included in the identified subset of transaction messages includes an addendum configured to store travel information, and
the identified propensity is further based on the travel information stored in the addendum included in the at least one transaction message.

15. The system of claim 14, wherein the identified propensity is further based on one or more transaction messages related to the at least one transaction message where a merchant category included in the transaction data values stored in the included plurality of additional data elements is representative of a parking, rental car, or transportation merchant.

16. A system for estimating demand of long-term parking, comprising:
a transaction database of a processing server configured to store a plurality of transaction messages, wherein each transaction message is formatted based on one or more standards and includes data related to an electronic transaction including at least a first data element configured to store a primary account number and a plurality of additional data elements configured to store transaction data values, and wherein a subset of the transaction messages further include an addendum configured to store travel data including at least a departure date and a departure location;
a receiving device of the processing server configured to receive a data signal superimposed with a parking demand request, wherein the parking demand request includes at least a geographic location and a range of one or more dates;
a querying module of the processing server configured to execute
a first query on the transaction database to identify a first group of transaction messages where the departure date and the departure location included in the travel data stored in the included addendum corresponds to the range of one or more dates and geographic location, respectively, and
a second query on the transaction database to identify a second group of transaction messages where the primary account number stored in the first data element included in the respective transaction message is included in the first data element included in a transaction message in the first group of transaction messages;
an analytical module of the processing server configured to identify a propensity to use long-term parking for each primary account number stored in the first data element included in a transaction message of the identified first group of transaction messages, wherein the propensity is based on at least the travel data stored in the addendum included in a transaction message in the first group of transaction messages where the included first data element stores the respective primary account number and the transaction data values stored in the plurality of additional data elements included in one or more of the transaction messages in the second group of transaction messages where the included first data element stores the respective primary account number;
an estimation module of the processing server configured to estimate a long-term parking demand based on at least the identified propensity to use long-term parking for each primary account number; and
a transmitting device of the processing server configured to electronically transmit a data signal superimposed with at least the estimated long-term parking demand.
